(19) United States
(12) Patent Application Publication
(10) Pub. No.: US 2017/0041688 A1
(43) Pub. Date: Feb. 9, 2017

(54) APPARATUS AND METHODS FOR TIMESTAMPING IN A SYSTEM SYNCHRONIZING CONTROLLER AND SENSORS

(71) Applicant: QUALCOMM Incorporated, San Diego, CA (US)

(72) Inventors: Radu Pitigoi-Aron, San Jose, CA (US); Leonid Sheynblat, Hillsborough, CA (US); Carlos Puig, Santa Clara, CA (US); Justin Black, Santa Clara, CA (US); Rashmi Kulkarni, Menlo Park, CA (US)

(21) Appl. No.: 15/299,408

(22) Filed: Oct. 20, 2016

Related U.S. Application Data
(63) Continuation-in-part of application No. 15/251,757, filed on Aug. 30, 2016.
Application No. 15/251,757 is a continuation of application No. 14/304,699, filed on Jun. 13, 2014, now Pat. No. 9,436,214.
(60) Provisional application No. 61/903,243, filed on Nov. 12, 2013.
(60) Provisional application No. 62/245,922, filed on Oct. 23, 2015.
(60) Provisional application No. 62/245,924, filed on Oct. 23, 2015.
(60) Provisional application No. 62/245,914, filed on Oct. 23, 2015.
(60) Provisional application No. 62/245,917, filed on Oct. 23, 2015.

(51) Int. Cl. H04Q 9/00; H04J 3/06

(52) U.S. Cl. CPC H04Q 9/00; H04J 3/0661; H04Q 2209/826; H04Q 2209/753

(57) ABSTRACT

Disclosed are methods and apparatus for synchronizing a controller and sensors in a system. A timestamp is provided in a host controller of an interface event on an interface coupled with host controller through detecting a message from a sensor on the interface that identifies the issuance of the interface event caused by the sensor at a first time. In response, the controller issues first and second events on the interface at respective second and third times, while concurrently counting cycles of a clock in the controller after each issuance. The controller also receives a first and second sensor counts representing the internal sensor clock times noted for the first and second events. The controller may then accurately calculate the timestamp of the interface event corresponding to the first time based on both internal controller counts and the sensor counts without needing a timestamp from the sensor directly.

### CLAIM OF PRIORITY UNDER 35 U.S.C. §120

The present application for patent is a Continuation in Part of U.S. patent application Ser. No. 15/251,757 entitled “SYSTEM AND METHODS OF REDUCING ENERGY CONSUMPTION BY SYNCHRONIZING SENSORS” filed Aug. 30, 2016, pending, and assigned to the assignee hereof and hereby expressly incorporated by reference herein, which claimed priority to U.S. patent application Ser. No. 14/304,699, now U.S. Pat. No. 9,436,214, which in turn claimed the benefit of priority of U.S. provisional patent application No. 61/903,243 filed on Nov. 12, 2013.

### CLAIM OF BENEFIT UNDER 35 U.S.C. §119

The present application for patent claims the benefit of U.S. Provisional Application No. 62/245,914 entitled “CORRECTION OF SYNC TICK IN A SYSTEM SYNCHRONIZING CONTROLLER AND SENSORS” filed Oct. 23, 2015, U.S. Provisional Application No. 62/245,917 entitled “ACHIEVING ACCEPTABLE CONTROL FOR THE RANGE OF SENSOR CLOCK TIMING IN A SYSTEM SYNCHRONIZING CONTROLLER AND SENSORS” filed Oct. 23, 2015, U.S. Provisional Application No. 62/245,922 entitled “REDUCTION OF TIME STAMP OVERHEAD IN A SYSTEM SYNCHRONIZING CONTROLLER AND SENSORS” filed Oct. 23, 2015, and U.S. Provisional Application No. 62/245,924 entitled “TIMESTAMP FOR ASYNCHRONOUS EVENT” filed Oct. 23, 2015, all of which are assigned to the assignee hereof and hereby expressly incorporated by reference herein.

### BACKGROUND

Field

The subject matter disclosed herein relates to electronic devices, and more particularly to methods, apparatus, and systems for timestamping in a system synchronizing controllers and sensors.

Background

Modern-day mobile devices contain many sensors. Usually, a data processing unit, controller, host device, or master device (hereinafter referred to as simply a controller or a host controller) is provided to receive and process data collected by sensors or slave units (hereinafter referred to a “sensor”). To conserve power, the controller is regularly placed into a sleep state when no data is being transferred from the sensors to the controller.

Two methods of transferring data from sensors to a controller are commonly utilized. In the first method, which is known as the asynchronous method, a sensor with available data to transfer notifies the controller by issuing a signal (e.g., a Data Ready Interrupt (DRI) signal through a dedicated DRI pin for certain known systems), which wakes up the controller, and then the sensor transfers the data when the controller is ready. In the second method, which is known as the synchronous method, the controller wakes up from the sleep state spontaneously at predetermined time intervals, polls the sensors, and receives from the sensors whatever data is present at the sensors. The synchronous method is more energy efficient in a device comprising multiple sensors because data transfers from more than one sensor may be consolidated into a single poll and transfer session.

In systems where multiple sensors or other devices provide periodically sampled data, it is further advantageous to be able to instruct the sensors to collect the data at essentially synchronized times, and for the controller to read the data from several sensors within the same awake time window or system awake period. Ideally, assuming a sensor delivers only the most current results, polling a sensor at a frequency that coincides with the sensor's sampling frequency is sufficient to obtain all the data collected by the sensor. However, because the controller and the sensors do not usually share timing signals and misalignment of the timing signals may therefore result, some sensor data samples may be lost and some sensor data samples may be read twice even when the sensors are polled at their sampling frequencies. The phenomenon is exacerbated by the fact that some sensors have poor clock or timer accuracy (e.g., ±15% deviation over a temperature range and from device to device).

Additionally in particular systems it is known that sensors might provide data on an interface or bus in a random or unexpected manner (i.e., an essentially “asynchronous” manner), whether the system as whole is intentionally being operating in an asynchronous data sampling mode or even is operating in a synchronous data sampling mode where random events might occur on the interface or bus. In such instances, it is desirable for the host controller to be able to acquire accurate time-of-occurrence information of when sensors or slave devices provide data in random or unexpected manners.

### SUMMARY

According to an aspect, a method for providing a timestamp in a host controller of an interface event on an interface coupled with host controller is disclosed. The method includes detecting a message from a sensor on the interface that identifies the issuance of the interface event caused by the sensor, the interface event occurring at a first time on the sensor. Additionally, the method includes issuing a first event on the interface at a second time after the first time in the response to the received message and starting a first count of cycles of a host controller clock, the start of the first count being concurrent with issuing the first event, and issuing a second event on the interface at third time after the second time. The method also includes receiving a first sensor clock count and a second sensor clock count from the sensor, where the first sensor clock count is a count of cycles of an internal sensor clock from the first time to the second time and the second sensor clock count is a count of cycles of the internal sensor clock from the second time to the third time. The host controller then determines the timestamp of the interface event corresponding to the first time based at least in part on the first count of cycles of a host controller clock, the first sensor clock count, the second sensor clock count, and a host controller timestamp of the second time.

According to another aspect, a host controller device is disclosed that includes a transport medium interface communicatively coupled to at least one sensor via at least one transport medium and at least one processing circuit communicatively coupled to the transport medium interface. The at least one processing circuit is configured to detect a message from the sensor on the interface that identifies the issuance of the interface event caused by the sensor, the interface event occurring at a first time on the sensor. The processor is further configured to issue a first event on the interface at a second time after the first time in the response to the received message and starting a first count of cycles of a host controller clock, the start of the first count being concurrent with issuing the first event, and issue a second event on the interface at third time after the second time. Furthermore, the receive a first sensor clock count and a second sensor clock count from the sensor, where the first sensor clock count is a count of cycles of an internal sensor clock from the first time to the second time and the second sensor clock count is a count of cycles of the internal sensor clock from the second time to the third time. Additionally, the processor is configured to determine the timestamp of the interface event corresponding to the first time based at least in part on the first count of cycles of a host controller clock, the first sensor clock count, the second sensor clock count, and a host controller timestamp of the second time.

According to yet another aspect, a processor-readable storage medium is disclosed, where the medium has one or more instructions which, when executed by at least one processing circuit, cause the at least one processing circuit to receive a message at host controller from a sensor on an interface communicatively coupling the host controller and the sensor, the message configured to identify the issuance of the interface event caused by the sensor and occurring at a first time on the sensor. Furthermore, the instructions cause the processor to issue a first event on the interface at a second time after the first time in the response to the received message and starting a first count of cycles of a host controller clock, the start of the first count being concurrent with issuing the first event, and to issue a second event on the interface at third time after the second time. The instructions also are configured to cause the at least one processor to receive a first sensor clock count (SC1) and a second sensor clock count (SC2) from the sensor, where the first sensor clock count is a count of cycles of an internal sensor clock from the first time to the second time and the second sensor clock count is a count of cycles of the internal sensor clock from the second time to the third time. Also, the instructions are configured to cause the at least one processor to determine the timestamp of the interface event corresponding to the first time based at least in part on the first count of cycles of a host controller clock, the first sensor clock count, the second sensor clock count, and a host controller timestamp of the second time (MREF).

According to still another aspect, a method is disclosed for providing a time of measurement associated with sensor sample data. The method includes determining a beginning time of a present time phase (T_Ph) period in a host controller. Furthermore, the method includes determining a time position of a sensor sample data transmission within a sequence of sensor sample data transmissions within the present phase time period. Yet further, the method includes determining the time of measurement associated with the sensor sample data transmission based on the beginning time of the present phase time period and the time position of the sensor sample data transmission within the sequence of sensor sample data transmissions within the present phase time period.

### BRIEF DESCRIPTION OF THE DRAWINGS

FIG. 1 is block diagram illustrating an exemplary mobile device in which the presently disclosed methods and apparatus may be implemented.

FIG. 2 is block diagram illustrating an exemplary hardware environment in which the presently disclosed methods and apparatus may be implemented.

FIG. 3 is a flowchart illustrating an exemplary method for synchronizing a host controller and sensor timers.

FIG. 4 illustrates a timeline diagram showing sensor and host controller timestamping according to presently disclosed methodology

FIG. 5 illustrates a timeline diagram showing a simplified timeline diagram of the timelines of FIG. 4.

FIG. 6 illustrates a timeline diagram showing an example of dynamic scaling of sensor timer counts.

FIG. 7 illustrates a flowchart of an exemplary method of providing a timestamp of an interface event according to an aspect.

FIG. 8 illustrates a flowchart illustrating an exemplary method for providing sensor counts used in determining a timestamp of an interface event according to an aspect.

FIG. 9 is a timeline illustrating an example of messages on an interface over time.

FIG. 10 illustrates a flow diagram of a method for reducing timestamping overhead.

FIG. 11 illustrates an exemplary host controller or master device according to the present disclosure.

FIG. 12 illustrates an exemplary slave or sensor device according to the present disclosure.

FIG. 13 is a diagram illustrating a simplified example of a hardware implementation for a host controller.

FIG. 14 is a diagram illustrating another simplified example of a hardware implementation for a host controller.

### DETAILED DESCRIPTION

Aspects of the disclosed methods and apparatus are disclosed in the following description and related drawings directed to specific embodiments. Alternate embodiments may be devised without departing from the scope of the present disclosure. Additionally, well known elements may not be described in detail or may be omitted so as not to obscure the relevant details of the disclosure.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device (e.g., a server or device). It will be recognized that various actions described herein can be performed by specific circuits (e.g., application specific integrated circuits), by program instructions being executed by one or more processors, or by a combination of both. Additionally, these sequences of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

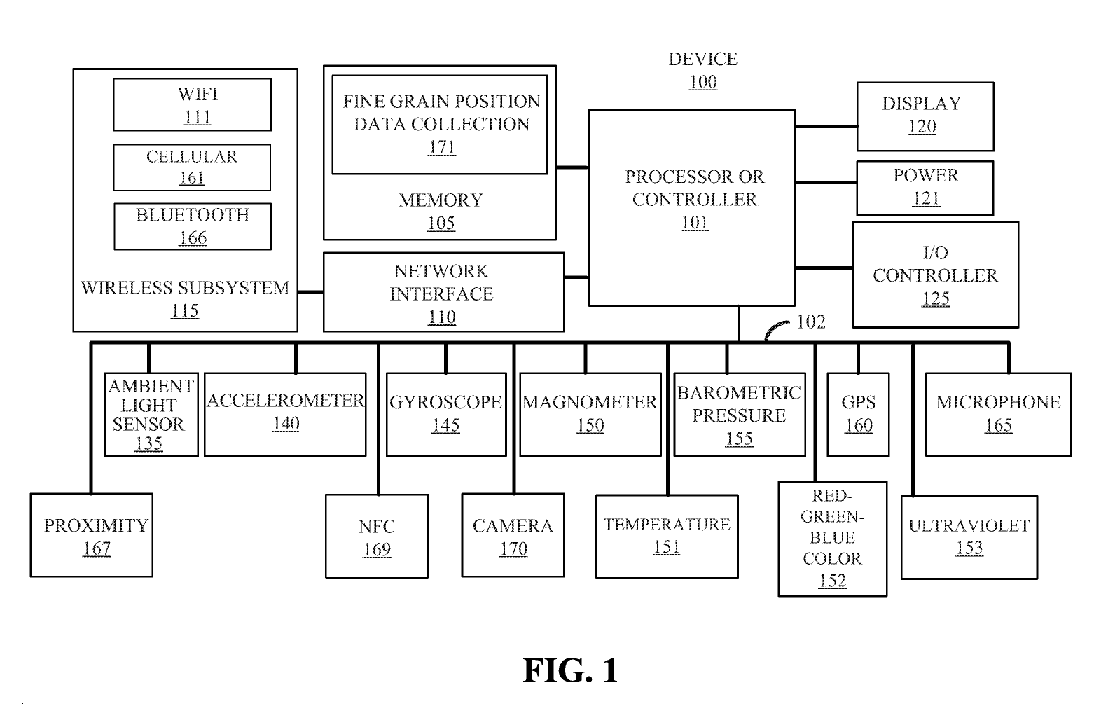

FIG. 1 is block diagram illustrating an exemplary mobile device in which embodiments of the presently disclosure may be practiced. The system may be a device (e.g., device 100), which may include one or more processors 101, a memory 105, I/O controller 125, and network interface 110. Device 100 may also include a number of device sensors coupled to one or more buses or signal lines further coupled to the processor 101. It should be appreciated that device 100 may also include a display 120, a user interface (e.g., keyboard, touch-screen, or similar devices), a power device 121 (e.g., a battery), as well as other components typically associated with electronic devices. In some embodiments, device 100 may be a mobile or non-mobile device. Herein “processor” and “data processing unit” are used interchangeably.

The device (e.g., device 100) can include sensors such as ambient light sensor (ALS) 135, accelerometer 140, gyroscope 145, magnetometer 150, temperature sensor 151, barometric pressure sensor 155, red-green-blue (RGB) color sensor 152, ultra-violet (UV) sensor 153, UV-A sensor, UV-B sensor, compass, proximity sensor 167, near field communication (NFC) 169, and/or Global Positioning Sensor (GPS) 160. In some embodiments, multiple cameras are integrated or accessible to a device. For example, a mobile device may have at least a front and rear mounted camera. In some embodiments, other sensors may also have multiple installations or versions.

Memory 105 may be coupled to processor 101 to store instructions for execution by processor 101. In some embodiments, memory 105 is non-transitory. Memory 105 may also store one or more models or modules to implement embodiments described below. Memory 105 may also store data from integrated or external sensors.

Network interface 110 may also be coupled to a number of wireless subsystems 115 (e.g., Bluetooth 166, WiFi 111, Cellular 161, or other networks) to transmit and receive data streams through a wireless link to/from a wireless network, or may be a wired interface for direct connection to networks (e.g., the Internet, Ethernet, or other wired or wireless systems). The mobile device may include one or more local area network transceivers connected to one or more antennas (not shown). The local area network transceiver comprises suitable devices, hardware, and/or software for communicating with and/or detecting signals to/from wireless APs, and/or directly with other wireless devices within a network. In one aspect, the local area network transceiver may comprise a WiFi (802.11x) communication system suitable for communicating with one or more wireless access points.

The device 100 may also include one or more wide area network transceiver(s) that may be connected to one or more antennas. The wide area network transceiver comprises suitable devices, hardware, and/or software for communicating with and/or detecting signals to/from other wireless devices within a network. In one aspect, the wide area network transceiver may comprise a CDMA communication system suitable for communicating with a CDMA network of wireless base stations; however in other aspects, the wireless communication system may comprise another type of cellular telephony network or femtocells, such as, for example, TDMA, LTE, LTE Advanced, WCDMA, UMTS, 4G, 5G, or GSM. Additionally, any other type of wireless networking technologies may be used, for example, WiMax (802.16), Ultra Wide Band, ZigBee, wireless USB, etc.

Additionally device 100 may be a mobile device, a wireless device, a cell phone, a personal digital assistant, a mobile computer, a wearable device (e.g., head mounted display, virtual reality glasses, etc.), a robot navigation system, a tablet, a personal computer, a laptop computer, or any type of device that has processing and/or communication capabilities. As used herein, a mobile device may be any portable or movable device or machine that is configurable to acquire wireless signals transmitted from, and transmit wireless signals to, one or more wireless communication devices or networks. Thus, by way of example, but not limitation, the device 100 may include a radio device, a cellular telephone device, a computing device, a personal communication system device, or other like movable wireless communication equipped device, appliance, or machine. Any operable combination of the above are also considered a “mobile device.”

Furthermore, the mobile device 100 may communicate wirelessly with a plurality of wireless access points (APs), NodeBs, eNodeB's, base stations, etc. using RF signals (e.g., 2.4 GHz, 3.6 GHz, and 4.9/5.0 GHz bands) and standardized protocols for the modulation of the RF signals and the exchanging of information packets (e.g., IEEE 802.11x).

It should be appreciated that examples as will be hereinafter described may be implemented through the execution of instructions, such as instructions stored in the memory 105 or other element, by processor 101 of the device 100 and/or other circuitry of device 100. Particularly, circuitry of device 100, including but not limited to processor 101, may operate under the control of a program, routine, or the execution of instructions to execute methods or processes in accordance with embodiments of the invention. For example, such a program may be implemented in firmware or software (e.g. stored in memory 105 and/or other locations) and may be implemented by processors, such as processor 101, and/or other circuitry of device. Further, it should be appreciated that the terms processor, microprocessor, circuitry, controller, etc., may refer to any type of logic or circuitry capable of executing logic, commands, instructions, software, firmware, functionality and the like.

Further, it should be appreciated that some or all of the functions, engines or modules described herein may be performed by device itself and/or some or all of the functions, engines or modules described herein may be performed by another system connected through I/O controller 125 or network interface 110 (wirelessly or wired) to device. Thus, some and/or all of the functions may be performed by another system and the results or intermediate calculations may be transferred back to the device 100. In some embodiments, such other devices may include a server configured to process information in real time or near real time. In some embodiments, the other device is configured to predetermine the results, for example based on a known configuration of the device. Further, one or more of the elements illustrated in FIG. 1 may be omitted from the device 100. For example, one or more of the sensors 130-165 may be omitted in some embodiments.

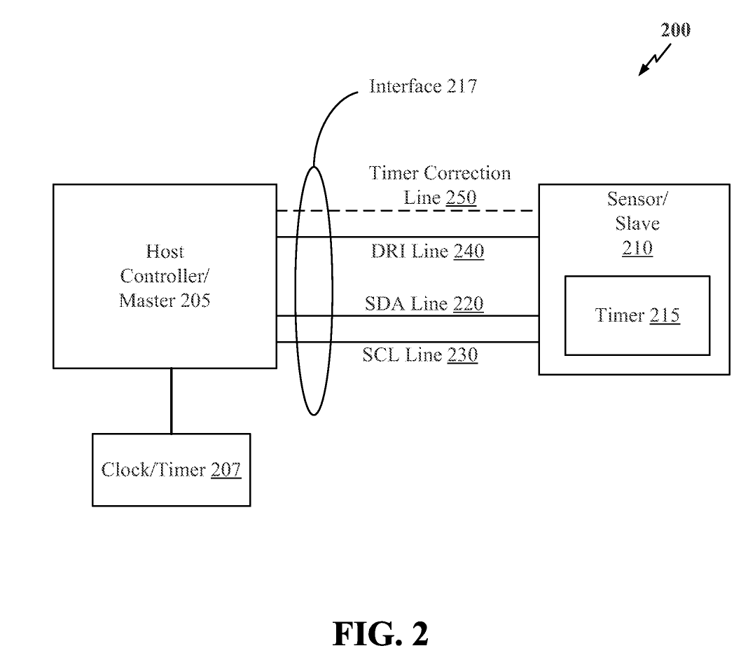

FIG. 2 is block diagram illustrating an exemplary hardware environment 200 in which aspects of the present disclosure may be practiced. A host controller 205 (or master) may be provided to receive and process data samples transferred from a sensor 210 (or any other device that provides sampled data to a host or master), among other functions. In an example, the host controller 205 may be implemented by or within processor 101 of device 100, but is not limited to such and may be implemented separate from processor 101. Sensor 210 may be a sensor of any type, such as those described above, or any device that collects and sends sampled data. The presently disclosed embodiments are not limited by the number of sensors, and more sensors (not shown) may be present. In some embodiments, host controller 205 may be provided with a clock or timer signal from a clock 207. In other embodiments, an internal clock generator may be embedded with controller 205. Sensor 210 includes an internal timer generator 215, which generates a timer signal for timing the collection and transmission of samples by sensor 210. A data connection, bus, or interface 217 links the processor 101 with the sensor 210 and allows for, among other things, timing of the transfer of data between the host controller 205 and the sensor 210. In the example shown in FIG. 2, the data connection may be an Inter IC bus (I²C bus) or an I3C bus including a Serial Data (SDA) line 220 and a Serial Clock (SCL) line 230. Both SDA line 220 and SCL line 230 may be pulled up with pull-up resistors (not shown). The operation of I²C or I3C busses are known in the art, and will not to be described in detail here for sake of brevity.

The data connection may also be a universal asynchronous receiver/transmitter (UART) connection, a Serial Peripheral Interface (SPI) bus, a System Management Bus (SMBus), a Serial Low-power Inter-chip Media Bus (SLIMbus™), a SoundWire bus, a wireless interface, or any other type of connection suitable for transferring data between a processor and a sensor. In some embodiments, sensor 210 may have a Data Ready Interrupt (DRI) pin, which may be connected to controller 205 via a DRI line 240. In embodiments where more than one sensor is present, DRI lines from the multiple sensors may be multiplexed before being connected to processor 101. In some other embodiments, in addition to or instead of a DRI pin, sensor 210 may have a dedicated clock correction pin, which may be connected to processor 101 via a clock correction line 250.

Computing device 100 may comprise a sensor 210 including or coupled to a sensor timer 215 and a host controller 205 including or coupled to a clock or timer 207 to: correct the sensor timer 215 for a first time, transfer data from the sensor 210, and correct the sensor timer 215 for a second time, wherein a time interval between two corrections of the sensor timer 215 may be selected such that the sensor timer 215 is sufficiently aligned with the host controller timer 207 over the time interval.

Two methods of transferring data from sensor 210 to host controller 205 are commonly utilized. In the first method, also known as the asynchronous method, a sensor 210 with available data to transfer may notify host controller 205 by issuing a Data Ready Interrupt (DRI) signal through a dedicated DRI pin, which wakes the processor up from the sleep state, and transfers the data when the processor is ready for the data transfer. In the second method, also known as the synchronous method, host controller 205 may wake up from the sleep state spontaneously at predetermined time intervals, and may poll sensor 210 to receive data. The synchronous method is more energy efficient in a device comprising multiple sensors because data transfers from more than one sensor may be consolidated into a single poll and transfer session.

Ideally, assuming a sensor delivers only the most current result, polling a sensor at a frequency that coincides with the sensor's sampling frequency is sufficient to obtain all the data samples collected by the sensor. However, because host controller 205 and sensor 210 do not usually share a clock or timing signal and misalignment of the timing of respective timers may result, some sensor data samples may be lost and some sensor data samples may be read twice even when sensor 210 is polled at its sampling frequency. The phenomenon may be exacerbated by the fact that some sensors may have very poor timer accuracy (i.e., ±15% deviation over the temperature range and from device to device).

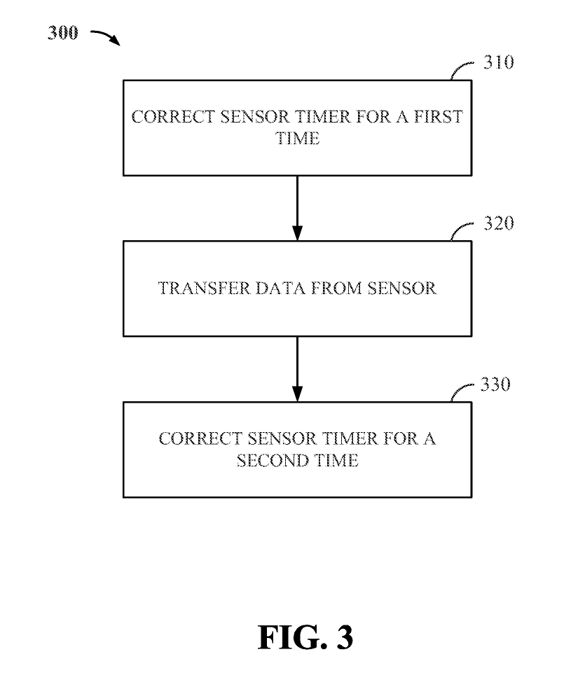

Referring to FIG. 3, a flowchart illustrating an exemplary method 300 for synchronizing sensor timing is shown. At operation 310, the sensor timer may be corrected for a first time. Correcting the sensor timer may comprise applying a timer correction factor to the internal timer on which the sampling events are based, such that the internal sensor timer is sufficiently aligned with the clock signal used by host controller clock or timer 207. The internal sensor timer 215 is sufficiently aligned with the processor clock, on which polling events are based, when it can be guaranteed for a sufficiently long period of time that polling the sensor at a frequency that coincides with the sensor's specified sampling frequency will result in receiving all the sensor data samples, with no data sample being lost and no data sample being read twice. It should be noted that when two timer signals are perfectly aligned, the ratio between their real frequencies is equal to the ratio between their specified frequencies. At operation 320, sensor 210 may be polled by host controller 205, and sensor data samples may be transferred to host controller 205 from sensor 210. Operation 320 may consist of multiple polls and multiple data sample transfers. At operation 330, the sensor clock may be corrected for a second time in the same way it is corrected for the first time in operation 310. The time interval between two corrections of the sensor timer 215 may be selected such that the timer signals remain sufficiently aligned, as defined above, over the interval, inaccuracies of timer signals accumulated over the interval notwithstanding. If the interval selected is too short, energy may be wasted in correcting sensor timers 215 more often than needed. On the other hand, if the interval selected is too long, timer signals may become misaligned and data sample loss or repetition described above may occur.

The time interval between two sensor timer corrections may be referred to as the Phase Time or Time Phase interval (T_Ph). In particular, the Time Phase interval (T_Ph) may be a period of time provided by a host or master controller 205 that indicates a pre-established time duration that is used by the Slaves or Sensors 210 for adjusting their internal timers and the beginning of a sequence of sampling events. The “T” stands for “time” or “period” and “Ph” for “phase”, referring to the fact that the sequence of sampling events takes place within the same time period and begins at the same moment. In a particular aspect, the T_Ph may be defined in terms of a predetermined number of samples or sampling events in the sequence of sampling events. For example, the T_Ph may be defined in terms of 20 sampling events that occur in each T_Ph period.

By performing operations 310 through 330 repeatedly, the internal sensor timer 215 may be kept sufficiently aligned with the host controller clock. In some embodiments, T_Ph may be a common multiple of sampling periods of sensors present. For example, in an embodiment where three sensors having sampling frequencies of 200 Hz, 100 Hz, and 10 Hz (corresponding to sampling periods of 5 ms, 10 ms, and 100 ms), respectively, are present, 100 ms may be selected as the T_Ph. It should be appreciated that synchronizing a plurality of sensors substantially simultaneously using a T_Ph that is a common multiple of sampling periods of the plurality of sensors present aligns the sensor clocks with each other and therefore allows the processor to obtain all samples with the fewest wake windows with the synchronous method. In the above-mentioned example, if the sensor clocks of the three sensors with sampling frequencies of 200 Hz, 100 Hz, and 10 Hz are not aligned with each other, the processor may have to wake up a total of 310 times per second to obtain all samples in the worst case scenario, where the processor receives a single sample from a single sensor in each wake window (200 times per second for the 200 Hz sensor, 100 times per second for the 100 Hz sensor, and 10 times per second for the 10 Hz sensor). On the other hand, if the sensor timers of the three sensors are aligned as described above, the processor needs to wake up only 200 times every second to obtain all samples: the 200 Hz sensor is polled every time the processor wakes up; the 100 Hz sensor is polled every other time the processor wakes up; and the 10 Hz sensor is polled every 20 times the processor wakes up. Reducing the number of wake windows required is desirable because it conserves power and extends battery life. In some embodiments, T_Ph may be approximately 1 second. T_Ph may also be adjusted at run-time in embodiments where clock-related feedback information is provided by sensor 210.

A number of non-limiting methods for correcting the sensor timer 215 have been contemplated. In some embodiments, sensor 210 may receive information relating to the processor clock or timer, derive the timer or clock correction factor, and apply the timer correction factor. In some embodiments, sensor 210 may send information relating to its internal timer or clock to the host controller 205, receive the timer correction factor derived at host controller 205, and apply the timer correction factor.

For embodiments where timer-related information is exchanged between host controller 205 and sensor 210, a number of non-limiting methods for exchanging clock or timer related information have been contemplated. In some embodiments, the clock or timer information may be transferred using DRI line 240. In some embodiments, the clock or timer information may be transferred using a dedicated clock or timer correction line 250. In yet some other embodiments, the clock or timer information may be transferred using a regular data connection between processor 101 and sensor 210, such as an I²C or I3C bus described above.

In a first group of embodiments, sensor 210 may receive information relating to the processor timer or clock 207, derive the timer correction factor, and apply the timer correction factor when the sensor timer 215 is being corrected.

In one embodiment, when the sensor timer 215 is being corrected, host controller 205 may transmit a burst of pulses consisting of a predetermined number of pulses to sensor 210. The burst of pulses may be derived from the host controller timer and its frequency may be dependent on that of the host controller timer. The burst need last only a relatively short period of time. Here, sensor 210 may be configured a priori with the expected frequency of the burst. Once sensor 210 receives the burst, it may compare the frequency of the burst received with the expected frequency, derive a timer correction factor accordingly, and apply the timer correction factor to correct the internal sensor timer 215.

In another embodiment, when the sensor timer 215 is being corrected, host controller 205 may transmit two pulses to sensor 210, where the pulses are spaced by a predetermined time interval as measured by the processor timer. The time interval is chosen such that it can be reliably used to derive a timer correction factor to correct the sensor timer 215. This time interval may be referred to as the Frequency Time interval (T_Fq). In some embodiments, T_Fq may be in the range of a few milliseconds. In some embodiments, T_Fq is chosen to coincide with the shortest sensor sampling period present. In some other embodiments, T_Fq may be chosen to be as long as T_Ph. For example, T_Fq may be 1 second. Here, sensor 210 may be configured a priori with the predetermined T_Fq. Once sensor 210 receives the two pulses, it may compare the duration of the time interval bookended by the two pulses received, as measured by the sensor timer, with the predetermined T_Fq, also as measured by the sensor timer, derive a timer correction factor accordingly, and apply the timer correction factor to correct the internal sensor timer.

In yet another embodiment, when the sensor timer is being corrected, host controller 205 may transmit timer correction messages to sensor 210 over the data connection between host controller 205 and sensor 210 such that two identifiable significant edges generated during a transmission of timer correction messages are spaced by a predetermined T_Fq, as measured by the processor timer. As described above, the data connection between host controller 205 and sensor 210 may be an I²C bus or I3C bus. It may also be a UART connection, an SPI bus, or any other type of connection suitable for transferring data between a controller and a sensor. The predetermined T_Fq may be the same as described above. Here, sensor 210 may be configured a priori with the predetermined T_Fq. Once sensor 210 receives the timer correction messages, it may compare the duration of the time interval bookended by the two identifiable significant edges included with the timer correction messages, as measured by the sensor timer 215, with the predetermined T_Fq, also as measured by the sensor timer, derive a timer correction factor accordingly, and apply the timer correction factor to correct the internal sensor timer.

For example, in an embodiment where the data connection between host controller 205 and sensor 210 is an I²C or I3C bus, two clock correction messages may be transmitted. These two timer correction messages may be referred to as MS1 and MS2, respectively. T_Fq may be bookended by the falling edge on SDA line 220 in the START condition for MS1 and the falling edge on SDA line 220 in the START condition for MS2, or may alternatively be bookended by the rising edge on SDA line 220 in the STOP condition for MS1 and the falling edge on SDA line 220 in the START condition for MS2. In embodiments where T_Fq is chosen to be as long as T_Ph, only one timer correction message, e.g., MS1, may be required, and the MS1 message may be transmitted by processor 101, for example, at the beginning of each T_Ph. Thus, the time period T_Fq that is equal to T_Ph may be bookended by, for example, in one embodiment, the falling edges on SDA line 220 in the START condition for two consecutive MS1 messages. Of course, the invention is not limited by the examples provided herein. Moreover, the use of the I²C or I3C bus for the purpose of correcting the sensor timer 215 also allows for supplementary error correction procedures, fault detections, and abort commands, etc. For example, sensor 210 may transmit a timestamp or a message including time deviation information and host controller 205 may correct the subsequent streams of data accordingly. By utilizing this procedure, the accuracy requirements of T_Ph may be relaxed. Other ways of exploiting the bi-directional communication abilities of the PC or I3C bus for timer correction purposes have also been contemplated.

In a second group of embodiments, sensor 210 may send information relating to its internal timer to host controller 205, receive the timer correction factor derived at host controller 205, and apply the timer correction factor when the sensor timer 215 is being corrected.

In one embodiment, when the sensor timer 215 is being corrected, sensor 210 may transmit two pulses spaced by a predetermined T_Fq or ODR period as measured by the sensor timer to host controller 205. The predetermined T_Fq may be the same as described above. Here, host controller 205 may be configured a priori with the predetermined T_Fq. Once host controller 205 receives the two pulses, it may compare the duration of the time interval bookended by the two pulses received, as measured by the processor timer, with the predetermined T_Fq, also as measured by the processor timer, derive a timer correction factor accordingly, and transmit the timer correction factor to sensor 210 via the interface 217 between host controller 205 and sensor 210, such as an I²C or I3C bus. Sensor 210 then may receive the timer correction factor and apply it.

In a third group of embodiments, no timer correction factor is used. In these embodiments, the processor timer, or a signal derived from the processor timer, may be provided to sensor 210, and sensor 210 may base the sampling events directly on the processor timer or the signal derived from the processor timer. The processor timer or the signal derived from the processor timer may be transmitted using a dedicated line, a DRI line 240, or may be transmitted within messages transferred on the data connection between processor 101 and sensor 210.

In one embodiment, host controller 205 may generate a sampling timer signal based on the processor timer, and transmit the sampling timer to sensor 210. The frequency of the sampling timer may be the same as the sampling frequency of sensor 210. Sensor 210 may be configured to ignore its internal sensor timer and collect a sample only when it encounters a pulse in the sampling timer signal transmitted by host controller 205.

In one embodiment where multiple sensors are present, the frequency of the sampling timer signal generated by processor 101 may be selected such that the frequency of the sampling timer signal is a common multiple of sampling frequencies of sensors present. For example, for an embodiment where three sensors having sampling frequencies of 200 Hz, 100 Hz, and 10 Hz, respectively, are present, processor 101 may generate a sampling timer signal with a frequency of 200 Hz based on the processor timer and transmit the sampling timer signal to all three sensors. Then, the sensor with the 200 Hz sampling frequency may be configured to collect a sample at every pulse it encounters in the sampling timer signal; the sensor with the 100 Hz sampling frequency may be configured to collect a sample at every other pulse it encounters in the sampling timer signal; and the sensor with the 10 Hz sampling frequency may be configured to collect a sample at every 20th pulse it encounters in the sampling timer signal.

It should be appreciated that because the sampling timer is based on the host controller timer, sampling events of sensor 210 and polling events of host controller 205 may always be aligned. It should also be appreciated that in some embodiments, the sampling timer signal may serve as the polling signal as well at the same time. In another embodiment, the processor timer may be directly provided to sensor 210, and sensor 210 may base the sampling events on the processor timer instead of its internal sensor timer.

By utilizing the exemplary methods for synchronizing sensor timers described herein, a controller may coordinate timer corrections for sensors and receive all sensor data samples from multiple sensors in batches in an energy-efficient synchronous mode, without wasting energy in polling the sensors at a frequency that is higher than necessary.

A method for determining the frequency of re-synchronizing sensors by transmitting a single set of timer correction messages comprising one or more messages from the processor to the sensors has been contemplated. It should be appreciated that the frequency of re-synchronizing sensors is the multiplicative inverse or reciprocal of T_Ph.

According to further embodiments of the present disclosure, methods and apparatus are disclosed that utilize specific hardware (or hardware and software in another example) events for time-controlled synchronizing events. The specific hardware events may depend on the interface used, e.g., the event would differ between different interfaces such as I²C, I3C, SPI, etc. Nonetheless, the events may be identified with specific set of commands and data. In one example, such commands are sent within a same I²C or I3C transaction that is used for an otherwise normal data exchange (e.g., reading data from sensors); as such, the energy required is negligible. The time synchronizing events, in particular, may be sent by a host controller at T_Ph intervals. In an aspect, the time synchronizing event may be chosen among the several start (START) conditions that are known to occur on an interface.

According to another aspect, methods and apparatus are disclosed that allow a host controller to acquire accurate time-of-occurrence information in systems where sensors or other slave devices provide data samples on the interface in a seemingly asynchronous, random, or unexpected manner. For a wide range of applications, several degrees of accuracy are required for such information. Accurate timestamping of such events can be challenging, however, for several reasons such as (1) uncertainties in relation to processing availability either at the host controller side or at the sensor side; (2) asynchronous and non-correlated clocks between the host controller and sensor, which leads to non-correlated timers/counters of the host controller and of the sensor; (3) large clock frequency differences between the host controller and the sensor; and (4) energy efficiency requirements. Thus, the disclosed methods and apparatus provide timestamping at both a sensor and a host controller during instances of asynchronous interface or bus events, and then share the timestamping information from which the host controller can determine an accurate timing based on the information, while also doing so in a more efficient manner.

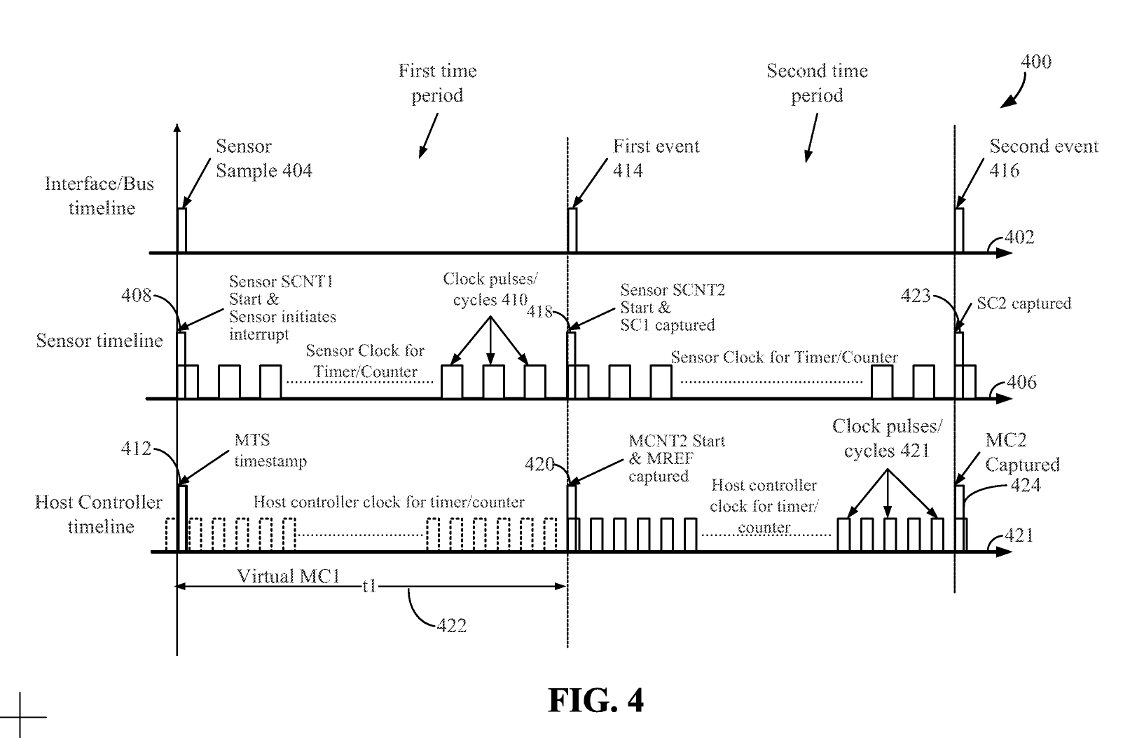

FIG. 4 illustrates an exemplary timeline diagram 400 showing sensor and host controller timestamping according to presently disclosed methodology. In particular, FIG. 4 illustrates processes during a relevant time period during and after a data transfer from a sensor to a host controller that allow the host controller to calculate the time at which the data sampling has taken place in a sensor despite that the controller itself is only capable of measuring and determining the number cycles of its own clock signal. It is noted that a presumption in this example is that a sensor is able to transfer data within a time interval during which a sensor's timer or counter is able to make accurate and meaningful measurements (i.e., that a driving clock for the timer possesses a sufficiently stable frequency to substantially increment a timer or counter in a linear manner with respect to time).

The disclosed methodology of FIG. 4 employs the use of hardware events issued by the host controller (e.g., 205 in FIG. 2) on the bus or interface (e.g., interface 217 in FIG. 2) after a random or unexpected event on the bus occurs, such as a sensor sample. As may be seen at a top timeline 402, which illustrates a timeline of events on the bus or interface, a sensor sample 404, which may be a random or unexpected sample, occurs at a particular time on the timeline 402. In an aspect, if the sensor issuing the sample 404 may be configured to then start a counter or timer of an internal sensor clock when particular events occur, such as its issuance of sensor sample 404. Accordingly, an internal sensor timeline 406 show that the sensor issuing sample 404 starts a counter or timer (termed Sensor Count 1 or “SCNT1”) at the time of the sensor sample 404 being transmitted on the interface or bus. According to one example, the counter or timer SCNT1 (as well as the other timers to be discussed herein) may be implemented with a register, termed herein as a “timer register.” The start of count SCNT1 is illustrated by pulse 408. At this point, the pulses of an internal clock of the sensor (shown at 410) are counted in the sensor. Additionally, the sensor is configured to issue an interrupt or message to the host controller at the same time as the sensor sample 404 as also illustrated by pulse 408 to indicate that the sensor has issued the sensor sample 404. The interrupt or message may be an interrupt request (IRQ) in I²C interfaces or an in-band interrupt (IBI) request in I3C interfaces.

According to an aspect, the host controller is configured to send first and second events 414 and 416 to the sensor separated in time on the bus or interface. These events are predetermined or in some similar way mutually identifiable by the sensor and the host controller, and may also be referred to as hardware time synchronization events (known also as HWSE). According to some aspects, the events 414 and 416 may be configured to be edges of already defined events on either SDA or SCL lines, in the example of I²C or I3C interfaces. For example, two successive edges (either rising or falling) of the SCL line may constitute the events as part of a defined sequence of I²C or I3C transactions. In another example, two selected edges of SCL clock on the SCL lines may be predetermined as the identifiable hardware events, such as the first SCL rising edges after an Acknowledgement (ACK) or a transition bit (T-bit) as one particular example. In another example, the interface events could be events that would occur on the bus or interface but are further independently identified as the interface events 414 and 416 by both the controller and the sensor. Based on reception of the events 414, 416, a sensor may transfer relevant time information to the host controller for use by the controller to determine or calculate an accurate time reference.

As indicated before, at the time of the sensor sample 404, the sensor may also issue an interrupt request (IRQ or IBI) as indicated at pulse 408. If the interrupt request is accepted at the host controller, then sensor is configured to record or store the first event 414 against its own timer or counter SC1 as indicated at 418. Also at the same time, the sensor will then start a second count of its internal clock (SCNT2) as also indicated at 418. Additionally, the host controller will record the first event 414 again its internal counter as indicated at 420 on timeline 421 of the host controller. In particular, the host controller records a master reference count (termed “MREF”) against its own clock and then also starts a second count (e.g., MCNT2) of the host controller's clock pulses or cycles 421 at the same time.

At some predetermined time after the first event 414, the host controller issues the second hardware event 416 as shown in timeline 402. As may be also be seen in FIG. 4, the first event 414 may be issued after a first time period 422 (or time “t1”), which may also be considered a virtual first predetermined count of the host controller clock cycles (also be referred to a first Master Count 1 (MCD) as it is not counted by later calculated as will be described in more detail later. Also at this time the host controller will initiate the first event 414 on the bus or interface.

Upon issuance of the first event 414, the sensor will capture the count of SCNT1 and store or buffer this first sensor count (termed “SC1” herein, and indicative of the number of the internal sensor clock pulses or cycles occurring between the time of the sensor sample 404 on interface and the first event 414 At the second event 416, the sensor captures or records the second count (SC2) against its own counter as shown at 423 in timeline 406. Additionally, the host controller records a count (MC2) at the occurrence of the second hardware event 416 against its own internal counter as shown at 424 in timeline 414.

It is desirable for the host controller to be able to determine or recover a timestamp for an interface event, such as for sensor sample 404. The present methods and apparatus afford a host controller the ability to determine a timestamp that accurately corresponds to the time of the sensor sample 404, for example, based on the counts that are sent from the sensor (e.g., counts SC1 and SC2, which may sent on the interface or bus through means of the interrupt request, for example, such that the payload of the interrupt request contains counts SC1 and SC2 and is sent by the sensor to the host controller on the interface after the occurrence of the second hardware event 416), as well as the counts in the host controller related to the issued first and second event 414, 416. To this end, the host controller determines a timestamp (illustrated at 412 on timeline 421 of the host controller) corresponding to sensor sample, which is termed herein as a Master Timestamp (MTS) and is expressed in time units of the host controller's internal clock. The determination of the MTS provides the host controller an accurate timing of the sensor sample 404 as it is was known internally by the sensor.

It is noted that the timelines, messages and events illustrated in FIG. 4 are implementable with any number of various interfaces and protocols with the messages sent across many different types of interfaces such that the methodology disclosed herein is not limited to any one type of interface. In a further aspect the methodology may be used on several or multiple interfaces as well as multiple interface protocols where several sensors may be synchronized against the internal time base of the host controller.

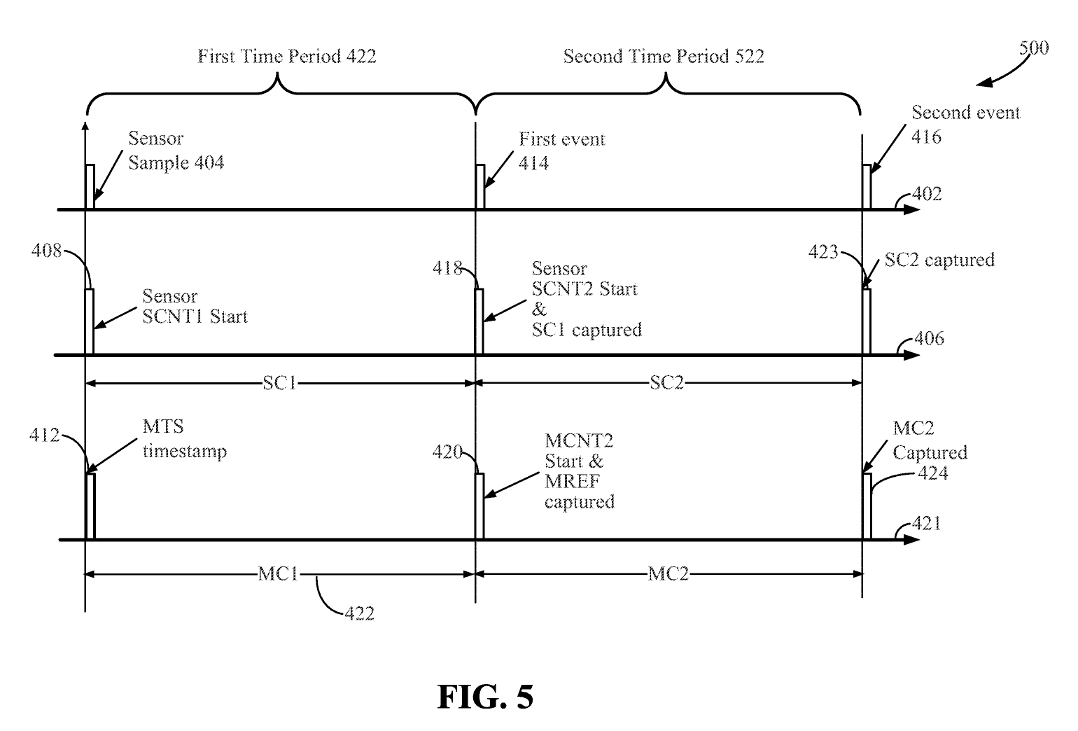

In order to more easily visualize the relationships between the timing of each of the counts SC1, SC2, MC1, and MC2, FIG. 5 illustrates a simplified timeline diagram 500 of the timelines of FIG. 4. As described before the host controller measures and determines the count MC2 from timestamp 420 to timestamp 424 in terms of the number of cycles of its own internal clock signal. Assuming that both the sensor's internal clock signal is sufficiently stable over the duration of the first and second time periods (i.e., the first time period 422 from the time of the sensor sample 404 to the time of the first event 414 (also shown as t1) and the second time period 522 from the time of the first event 414 to the time of the second event 416) the first time period 422, which may also considered as a virtual master count MC1.

Since the counts SC1, SC2, and MC2 are known after the second event 416, and the second time period 522 for count SC2 is the same as the count for MC2, and the first time period 422 for count SC1 will the same as the time period for count MC1, the unknown value for the number of host controller counts MC1 can be determined based on the ratios of three known counts SC1, SC2, and MC2. That is, the ratio of MC1 to SC1 will be equal to or proportional to the ratio of MC2 to SC2, again assuming clock stability over the first and second time periods. This is represented by equations (1) as follows:

$$\frac{MC 2}{SC 2} = \frac{MC 1}{SC 1} or \frac{MC 2}{MC 1} = \frac{SC 2}{SC 1} \qquad ( 1 )$$

Accordingly, solving for MC1 yields equation (2) as follows:

MC1=MC2×SC1/SC2 (2).

Equation (2) then provides the count of the host controller's internal clock cycles over the first time period 502, which is represented in terms of the number of host controller clock cycles. Accordingly, because the host controller establishes the master reference timestamp MREF (See 420) at the issuance of the first event 414, the MTS timestamp can be found from the subtraction of the determined count MC1 from the timestamp MREF. Since MC1 can be expressed in terms of MC2, SC1, and SC2 as given in equation (2) above, the MTS timestamp of the sensor event 404 as expressed in the controller's time units, may be calculated using equation (3) as follows:

MTS=MREF−MC2×SC1/SC2 (3).

From equation (3) above, the host controller is then able to determine a timestamp MTS that is the same as the timestamp of the sensor sample event 404 (or any other event where a sensor is configured to timestamp the event and issue a subsequent interrupt request) determined and assigned by the host controller, giving the host controller an accurate accounting of the timing.

Of further note, if the interrupt request (e.g., IRQ or IBI) is not immediately accepted by the host controller, the hardware events 414 and 416 will not issue unless the interrupt is accepted. Nonetheless, a sensor may be further configured to continue counting its own counter and wait for the next opportunity to have the interrupt request accepted. When the interrupt request is finally accepted, the sensor may be configured to proceed according to the processes as described above. It is noted in such case that the count of the first time period may be much greater than the count of the second time period, as the sensor continues counting as it waits for the interrupt request to be accepted and the subsequent hardware events 414, 416 to be issued. Although FIGS. 4 and 5 appear to illustrate that the first and second time periods 422 and 522 are roughly equal, this is not necessarily the case and those skilled in the art will appreciate that equation (3) above provides the correct timestamp regardless of the difference (or the degree of difference) between the counts over the respective two time periods 422 and 522.

According to other aspects, alternate means for retrieving the timestamp data from the sensor beyond a predetermined payload inclusion as part of an interrupt request may include the host controller issuing a directed command or message for retrieving the data from the sensors. In such case, the sensor may be configured to issue a supplementary confirmation that the timestamp data has been collected, to which the host controller may issue the directed command to retrieve that data from the sensor.

Of further note, it will be appreciated that if the count numbers from the sensor are zero, the host controller will assess that no timestamp is assigned to the event, whereas if the count numbers are non-zero, then the host controller will proceed with calculating the real timestamp (MTS) using its own timer counter. Additionally, any suitable clock, either permanent or burst, may be used as the sensor clock, as long as it is sufficiently stable during the first and second time periods 422 and 522. As these time periods are generally short, the sensor clock may in some embodiments be as simple as an RC oscillator or a ring oscillator. Additionally, it is noted that the illustrated frequencies or cycles per unit time of the sensor and host controller's clock signals are merely exemplary, and frequencies of the internal clocks and their frequencies relative to one another are not necessarily limited to those illustrated in the figures.

Because the host controller clock and the sensor clock may have vastly different frequencies, and the length of either the first time period 422 or the second time period 522 may be unpredictable, the sensor timer count values (e.g., SC1 and SC2) may become overly large and take up too much transmission or storage space or exceed the storage space of a timer register, thereby losing data. This is of particular concern in sensor devices as storage or buffering size is usually much less than storage for processor devices such as the host controller. Therefore, according to an aspect of the present disclosure methods and apparatus are disclosed to be able to reduce the count values in the sensors to ameliorate storage conditions for the timer count values, such as SC1 and SC2.

As will be appreciated by those skilled in the art, it is apparent from equations (2) and (3) that even if SC1 and SC2 were decreased by a common factor, such scaling would have no effect on the resultant timestamp calculation for MTS as the ratio SC1/SC2 would remain the same. Therefore, according to an aspect of the present disclosure methods and apparatus are disclosed for scaling timer count values (e.g., SC1 and SC2) in order to limit the size of transmission or storage space required by these timer values.

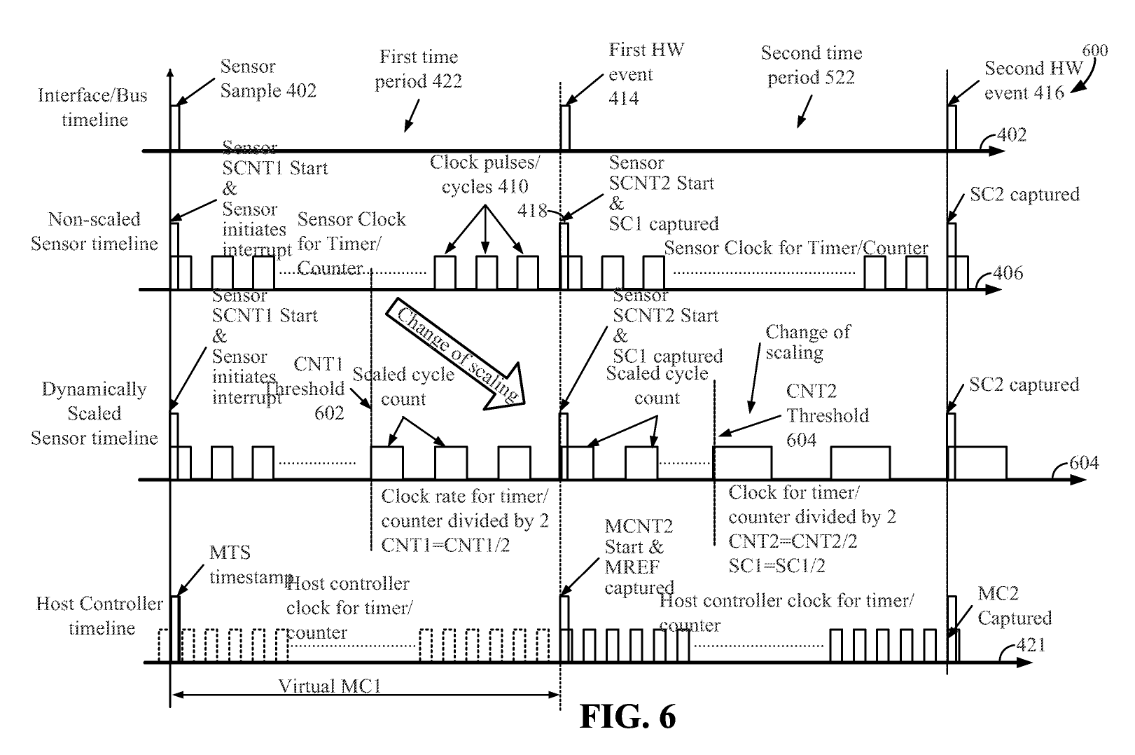

Turning to FIG. 6, this figure illustrates an example of dynamically scaling the sensor timer counts SC1 and SC2 during counting of the sensor clock during the first and second time periods 422, 522. During the first time period 422, in which the sensor timer counts the sensor clock cycles (CNT1), the counting rate may be halved (i.e., divided by 2) whenever the current count reaches a first predetermined threshold, which is shown as CNT1 threshold 602 in an alternative scaled timeline 604. Although not shown in FIG. 6, in an aspect this scaling may occur more than once during the first time period 422. As will be appreciated, halving the counting rate means doubling the number of clock cycles will result in incrementing the timer by 1. Thus, in the scaling at multiple instances, for example, at the beginning of SCNT1 the counter or timer increments by 1 for each clock cycle. After halving the counting rate at threshold 602, for example, the counter or timer increments by 1 for every other clock cycle. Next, if the count CNT1 would meet a next threshold (not shown in first time 422 in the example of FIG. 6), halving the counting rate for a second time would result in the counter or timer incrementing by 1 for every four clock cycles, and so on. Accordingly, the rate at which the sensor counts clock cycles is reduced by factors of 2, for example, but is not limited such a factor. Regardless, the reduction of the counting rate results in slowing the rate at which the counter storage or timer register is filled. It is noted here that scaling timeline 604 is shown in the context of the example of FIGS. 4 and 5, and is an alternative to the normal internal sensor counting illustrated in timeline 406.

Furthermore, when the count CNT1 reaches the threshold 604 and the rate of counting cycles is halved, the count value CNT1 is divided in half to obtain a lower value (or could be reset to start again at zero after the threshold count 602 in other envisioned aspects). In the present example, if the count threshold 602 is 2048 cycles, the count CNT1 may be divided by two (CNT1/2), as merely one example, and then the count would continue from 1024 at the scaled half rate (i.e., the clock rate divided by two).

At the conclusion of the first time period 422, the content of count storage or timer register is stored as the SC1 value, and the count storage or timer register may be reset to zero to begin the SCNT2 count during time period 522. As shown in FIG. 6, the counting rate is not reset, but rather continues at the half rate (i.e., counting every other pulse), although in other aspects the counting rate could be reset to count one for one and dynamically scaled again (if needed) as long as an accounting is made for the counting rates to ensure that the count values SC1 and SC2 are proportional before communicating the values to the host controller. Furthermore in another embodiment, two different sensor timer registers may be used for respectively counting CNT1 and CNT2 during the first and second time periods 422 and 522.

In the illustrated example of FIG. 6 the counting rate is not reset at the conclusion of the first time period 422. Thereafter during the second time period 522 the current count CNT2, the counting rate, and the stored SC1 value may be halved whenever the current count reaches a second predetermined threshold 604, or even further subsequent thresholds (not shown) over time period 522. By halving the stored SC1 value at each time the CNT2 is halved (CNT2/2), this ensures that the value of SC1 will remain proportional to the final SC2 count value. At the conclusion of the second time period 522, the content of the timer register is stored as the SC2 value. Those skilled in the art will appreciate that the above-described method amounts to reducing SC1 and SC2 values by a common factor so that the SC1 value will not exceed the first threshold, and the SC2 value will not exceed the second threshold, where the common factor is a power of 2 (2, 4, 8, 16 . . . ). Because the SC1 and SC2 values are reduced by a common factor to remain proportional to one another, the calculation of the master timestamp MTS is not affected.

In different embodiments, the SC1 and SC2 values may take up different transmission and storage space. For example, in one embodiment, the SC1 value may be limited to two bytes (16 bits), and the SC2 value may be limited to one byte (8 bits). Therefore, there may be a further limit to the ratio between the SC1 value and the SC2 value. Consequently, depending on the implementation, the size limit of the SC1 value, the interface events (which affect the second time period 522 and thus the SC2 value), and/or the thresholds used for scaling sensor timer values may need to be modified in order for the embodiments of the disclosure to work as intended.

In light of the methodology disclosed in connection with FIGS. 4-6, an accurate MTS timestamp for an unexpected and unpredictable event (e.g., sensor sample 402) may be determined by a host controller using two hardware interface events, along with clocks and timers in the sensor and the host controller despite the fact that the sensor and the controller may have unsynchronized clocks with vastly different frequencies. Additionally, by dynamically scaling the clock counting in at least the sensor devices, the methodology is also accomplished in a resource and energy-efficient fashion.

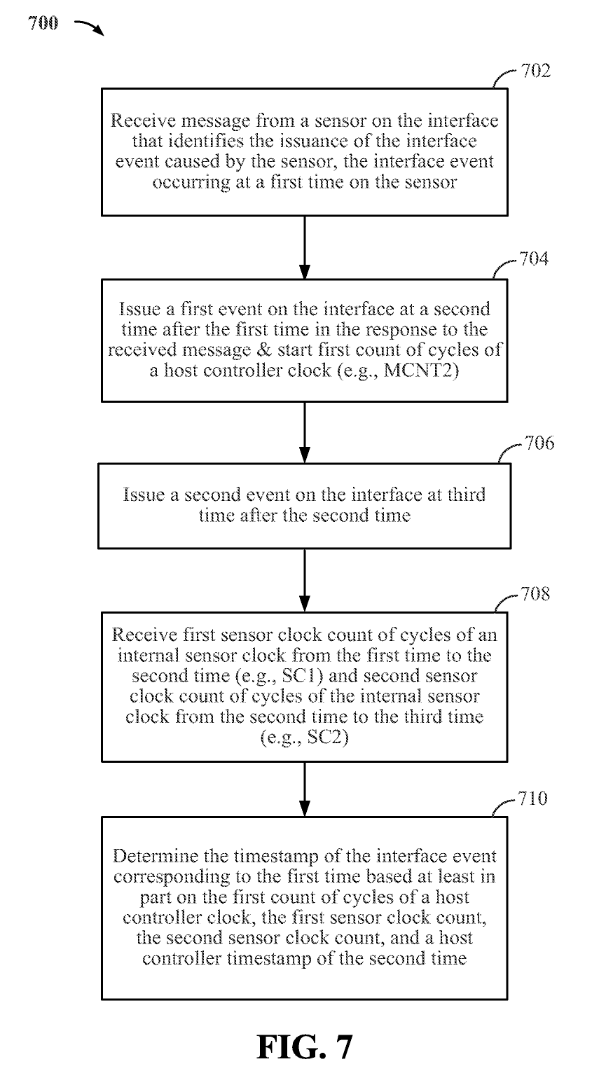

FIG. 7 illustrates a flowchart illustrating an exemplary method 700 for providing a controller with a timestamp of an event issued by a sensor or slave device. In an aspect, method 700 may be implemented by the host controller, such as host controller 205 as one example. At block 702, the host controller receives or detects a message from a sensor over the interface that identifies the issuance of the interface event caused by the sensor, the interface event occurring at a first time on the sensor. For example, the message may be an interrupt request (IRQ or IBI) from a sensor, although the message would not be limited to such, and the interface event may be the random or unexpected sensor sample 404. Additionally, this first time on the sensor is the internal time of the sensor clock when the sensor sample issues or occurs on the interface. Stated another way, the first time of the sensor is also correlative to the MTS to be determined, where the MTS is a calculated timestamp of this first time in terms of the host controller clock or timer.

After the message in the process of block 702 is received by the host controller, the host controller issues a first event on the interface at a second time after the first time in the response to the received message and starts a first count of cycles of a host controller clock where the start of the first count being concurrent with issuing the first event as shown at block 704. In an example, the processes of block 704 may include issuing the first event 414 at the timestamp 418 (i.e., the second time after the first time (e.g., MTS or timestamp 408 or the time of sensor sample 404). In another aspect, the start of the first count in the processes of block 704 may include the start of MCNT2 at timestamp 420 to derive the count MC2. After a prescribed or predetermined time period, the host controller then issues a second event (e.g., 416) on the interface at third time (e.g., timestamp 424) occurring after the second time (e.g., timestamp 420) as shown at block 706.

Method 700 further includes processes shown at block 708 including receiving a first sensor clock count (e.g., SC1) and a second sensor clock count (e.g., SC2) from the sensor, where the first sensor clock count is a count of cycles of an internal sensor clock from the first time to the second time and the second sensor clock count is a count of cycles of the internal sensor clock from the second time to the third time.

As shown at block 710, method 700 further includes determining within the host controller the timestamp of the interface event (e.g., MTS) corresponding to the first time (i.e., the time of the sensor sample 404 in the sensor) based at least in part on the first count of cycles of a host controller clock (MC1), the first sensor clock count (SC1), the second sensor clock count (SC2), and a host controller timestamp of the second time (MREF). As discussed above, the relationship of equation (3) may be utilized to determine the timestamp of the interface event (i.e., MTS) in terms of the host controller's clock or timer based on a reference timestamp at the first event (MREF) in terms of the host controller clock or timer, and the received counts SC1 and SC2 from the sensor. In another alternative, it is also contemplated that the individual counts SC2 and SC2 would not necessarily need to be received by the host controller. Instead, the sensor may be configured to transmit the ratio SC1/SC2 assuming that the sensor possesses arithmetic processing resources to be able to first calculate the ratio.

According to other aspects of method 700, the host controller and the sensor are communicatively coupled via an I²C, an I3C, an SPI, an SMBus, a SLIMbus, a UART, a SoundWire bus, or a wireless interface as well. Additionally as discussed before, each of the first and second events will comprise a predetermined hardware event that is mutually known to both the host controller and the sensor.

According to further aspects, method 700 may also include the received first sensor clock count and second sensor clock count comprising reduced count number values that are reduced by a common factor such that a ratio of the first sensor clock count and the second sensor clock count remains constant regardless of the value of the common factor, as was discussed previously with respect to FIG. 6. The reduction of the values of the first and second sensor clock counts by the common factor further comprises reducing a current count of the first sensor clock count by a factor of two (2), reducing a rate of counting the first sensor clock count by a factor of two (2); reducing a current count of the second sensor clock count by at least a factor of two (2); reducing a rate of counting the second sensor clock count by at least a factor of two (2); and dividing a stored count of first sensor clock count by a factor of two (2) when the current count of the second sensor clock count is reduced by at least a factor of two (2).

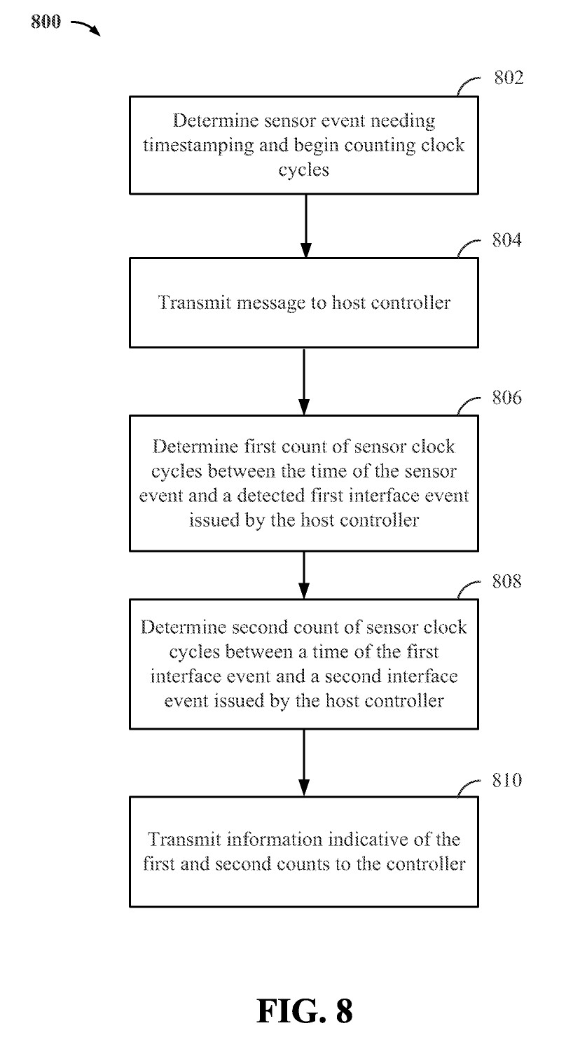

FIG. 8 illustrates a flowchart illustrating an exemplary method for providing sensor counts used in determining a timestamp of an interface event according to the presently disclosed methodology. The method 800 may be implemented at the sensor or slave device (e.g., sensor 210) according to an aspect. At block 802, the sensor determines a sensor event needing timestamping (e.g., sample event 404) and begins counting clock cycles of the sensor's internal clock or timer. After or concomitantly with the sensor determining an event needing timestamping, the sensor transmits a message to host controller as shown at block 804. The message may be an interrupt request, such as an IRQ or IBI, or some other message or signal configured to alert the host controller of the event in order for the host controller to initiate the process for accurately determining a timestamp of the sensor event in terms of its own internal clock (e.g., issuing the first and second interface events).

After the message is sent according to the process of block 804, the sensor will continue to count the cycles of its internal clock or time at then determine a first count of the sensor clock cycles between the time of the sensor event and a detected first interface event issued by the host controller as indicated at block 806. According to an example, this first count is count SC1, as discussed above. After the detection of the first interface event, the sensor will commence determining a second count of sensor clock cycles between the time of the first interface event and a second interface event issued by the host controller as shown in block 808. According to an example, this second count is count SC2 as discussed above. Finally at block 810, the sensor transmits information indicative of the first and second counts to the controller. As discussed above, in an aspect this information may include messaging from the sensor to the host controller providing the values of counts SC1 and SC2. In another alternative, it is contemplated a value indicative of the ratio of the counts SC1 and SC2 could be provided by the sensor to host controller.

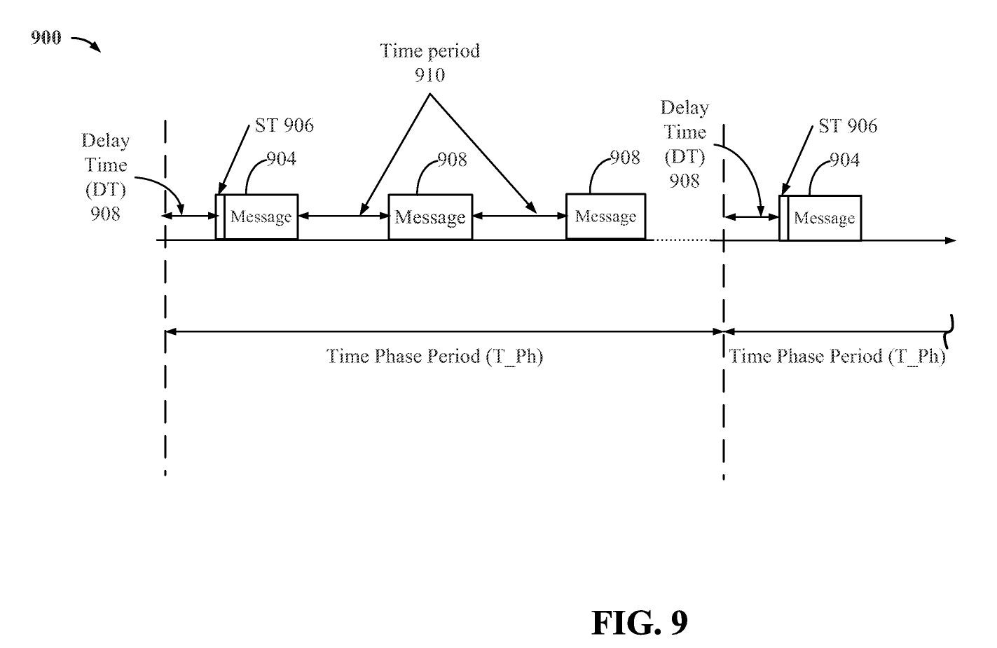

With regard to another embodiment of the present disclosure for reducing timestamp overhead, FIG. 9 illustrates a timeline diagram 900 showing example messages on an interface over time. Messages 902 and 904, which are transmitted from a host processor to sensors are adjacent to special messages each including a synchronization signal (e.g., a Sync Tick (ST) edge or message) 906 with which sensors may correct their internal timers used for synchronization. The time period between the ST edges/messages is ideally the time phase period T_Ph. However, due to the hardware, firmware, and/or software overhead, there may be a delay (e.g., a Delay Time, or “DT” 908) between the expected beginning of new T_Ph periods and the transmissions of ST edges/messages. To compensate for the potential inaccuracies that may result from unpredictable and variable Delay Time periods, the Delay Time periods may be measured and information indicating the respective Delay Time period may be transmitted after the transmission of ST edge/message. Based on the timing of the ST edge/message and the information indicative of the DT, the sensors may determine the expected beginning of new T_Ph periods. Special messages 902 and 904 may also include polling or other messages, in response to which the sensors may transmit sensor sample data back to the host controller. Although messages 902 and 904 are particularly suited for I2C or I3C bus protocols, it is noted that equivalently functioning messages may be sent over any one a number of different interfaces. The sensors may also transmit timestamps indicating the data sample measurement time based on their own respective sensor clocks. The timestamps may be in any suitable form, such as part of an I²C or I3C bus response message along with the sensor sample data, as a dedicated message if a faster protocol such as SPI is used, or on a separate connection between the host controller and the sensor. Additional messages 908, such as polling messages, etc., may be transmitted from the host controller to the sensors between the transmissions of those messages 902, 904 that are adjacent ST edges/messages 906. In response to polling messages, sensors may transmit sensor sample data and possibly timestamps.

It is further noted here that the information used by host controller to indicate the Delay Time period may indicate that the delay period is expressed in approximate 1/n periods of time units of the T_Ph period, where n is the number 2 to some predetermined power. The delay time is measured and transferred using the fractional 1/n units of T_Ph as a measuring unit, which allows truncation of the amount of information needed to be transmitted to communicate the delay time. Accordingly, the delay time can be expressed as a number of such measuring units. Based on the timing of the synchronization message and the information indicative of the Delay Time periods, the sensors/slaves may then determine the expected beginning of new T_Ph periods. As a numerical example, if T_Ph is one (1) second and n=2¹¹, this means that the measuring unit is one (1) second divided by 2 to the power of 11 (i.e., 2¹¹=2048). The time measuring unit 1/n is, in this particular case, 1 sec/2048, which equals 488 microseconds s). Hence, if the real delay time was 4 milliseconds (ms), for example, then the DT could be expressed by the number 8 as 4 ms/488 μs≈8. Thus, the DT message from the host controller will communicate the number 8 to the sensor/slave. In turn, the sensor/slave can reconstruct the DT based on its own counter/timer that it uses for counting 1 second. If the sensor/slave has a 2 MHz based counter, for example, its total count of cycles for one second is 2,000,000. For the sensor, one DT unit would be 2,000,000/2048=976 counter/timer cycles. The 8 time units communicated by DT message then translates for the sensor/slave's timer to be 976×8=7808 counter/timer cycles of the 2 MHz sensor base clock. Consequently, the sensor/slave will then deduct or subtract 7808 counter/timer cycles from the timestamp that the sensor/slave has recorded for the synchronizing event as indicated by ST, for example. The new number of sensor/slave's cycles is then the correct duration of the T_Ph and will be used for the expected beginning of a next T_Ph period.

In an embodiment, the host controller may determine the sensor sample data measurement time without the sensors transmitting the timestamps, thus reducing timestamp overhead in a system synchronizing controllers and sensors and the additional energy consumed due to the transmission of timestamps. As the first transmission of the sensor sample data 904 within a T_Ph period lags behind the corresponding time of measurement by a Delay Time period as a result of the sensors synchronizing their clocks based on both the ST edges/messages and Delay Time information (e.g., measurements are perfectly aligned with the T_Ph periods, while the actual transmissions may be affected by the Delay Time period), the time of measurement may be determined based on the starting time of the present T_Ph period, the Delay Time period, and the location of the transmission within the sequence of transmissions within the same T_Ph period. As the sample data measurements and transmissions are spaced equally in time as shown by equal time periods 910 (also these periods may be thought of as differences between the sensor data transmission time positions on the timeline) as merely two examples, linear interpolation may be used to determine the data measurement time based on the location of the transmission within the sequence of transmissions within the same T_Ph period, such as those shown in FIG. 9. For example, for a sensor that collects and transmits three data samples in each T_Ph period (counting the transmission at exactly the beginning of the T_Ph period, not counting the transmission at exactly the end of the T_Ph period, which is the beginning of the next T_Ph period), the time of measurement for the sample data transmitted at the first transmission is the beginning time of the T_Ph period, while the time of measurement for the sample data transmitted at the second transmission is one third of the T_Ph period after the beginning time of the T_Ph period, and the time of measurement for the sample data transmitted at the third transmission is two thirds of the T_Ph period after the beginning time of the T_Ph period. In another embodiment, a non-linear interpolation may be used if the non-linear relationship of the timing of sensor data transmissions is known.

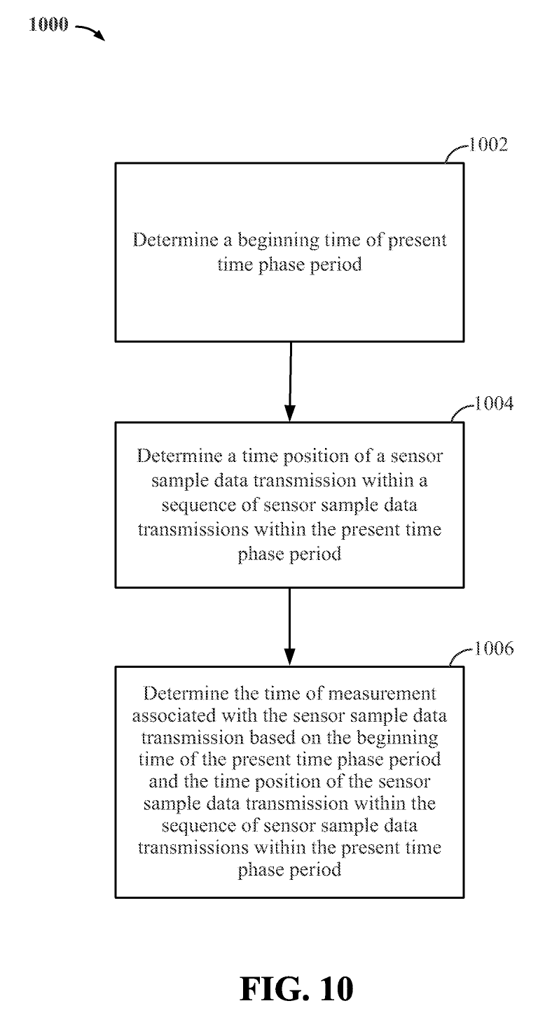

Referring to FIG. 10, a flowchart illustrating an exemplary method 1000 for determining a time of measurement associated with sensor sample data is shown. At block 1002, a beginning time of a present time phase (T_Ph) period may be determined, such as at a host controller. At block 1004, a time position of a sensor sample data transmission within a sequence of sensor sample data transmissions (i.e., determining the relative position of the sensor sample data along the timeline of sensor sample data transmissions) within the present phase time period may be determined. At block 1006, the time of measurement associated with the sensor sample data transmission may be determined based on the beginning time of the present phase time period and the position of the sensor sample data transmission within the sequence of sensor sample data transmissions within the present phase time period. The time of measurement associated with the first sensor sample data transmission within the present phase time period may be the beginning time of the present phase time period. Furthermore, the time of measurement associated with other sensor sample data transmissions within the present phase time period may be determined using linear interpolation based on the relative position of the sensor sample data transmission within the sequence of sensor sample data transmissions within the present phase time period and a number of transmissions within the sequence.

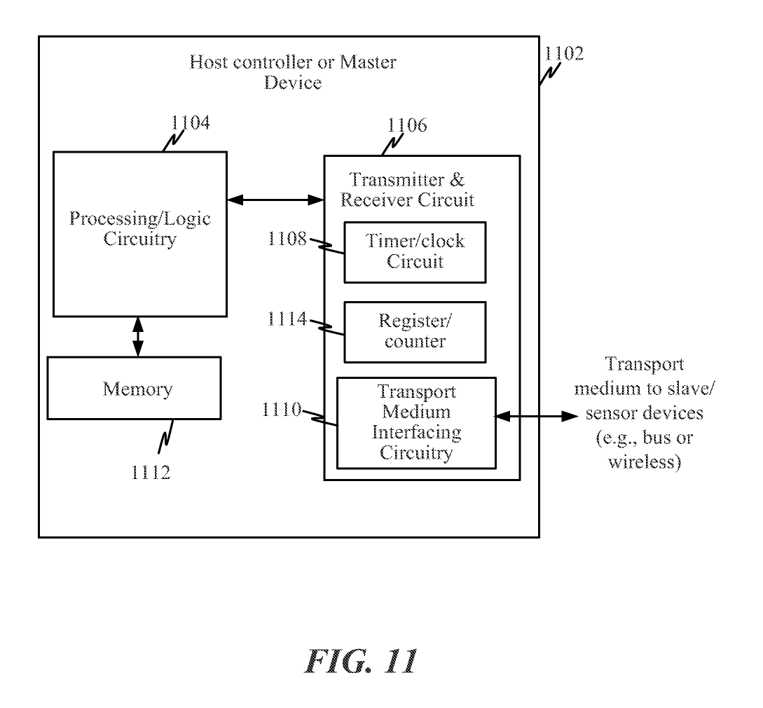

FIG. 11 illustrates an exemplary host controller or master device 1102 that may include processing or logic circuitry 1104 coupled with a transmitter/receiver circuitry 1106 for transmitting and receiving signals, commands, and data on a bus interface or circuit communicatively coupled with at least slave or sensor devices. The transmitter/receiver circuitry 1106 may include a timer or clock circuitry 1108 used at least for internal timing for the host controller 1102. It is noted that although timer or clock circuitry 1108 is illustrated within the transmitter/receiver circuit 1106, this circuitry or function may be implemented instead within the processing/logic circuitry 1104. Although not shown, the host controller 1102 may also employ other clocking or timing devices for internal clocking, such as clocking for the processing circuitry 1104, as an example. Further, the transmitter/receiver circuitry 1106 also include a transport medium interfacing circuit 1110 configured to interface the transmitter/receiver circuitry with the physical interface, which may an I²C or I3C bus or a wireless interface, as examples. Furthermore, the transport medium interface may employ at least two lines such as an SDA line and SCL line, but could include further lines as discussed earlier with respect to interface 217 in FIG. 2.

The host controller 1102 also may include a memory or storage medium 1112 coupled with at least the processing circuitry 1104 and include code or instructions for causing the circuitry 1104 to implement or direct the transmitter/receiver circuit 1106 to implement the various methodologies disclosed herein, such as those disclosed in connection with FIGS. 3-10.

In another aspect, the host controller 1102 may include a register or some other counter 1114 that performs some or all of the functions of effecting the methods as disclosed in FIGS. 3-10. In particular, the counter 1114 is used to count cycles of the timer/clock circuit 1108 to derive the MC2 (e.g., clock cycles 421 as shown in FIG. 4). Additionally, it is noted here that the timer/clock circuit 1108 or the time/clock circuit 1108 in conjunction with the processing/logic circuitry 1104 may be used to determine timestamps, such as the MREF timestamp discussed earlier.

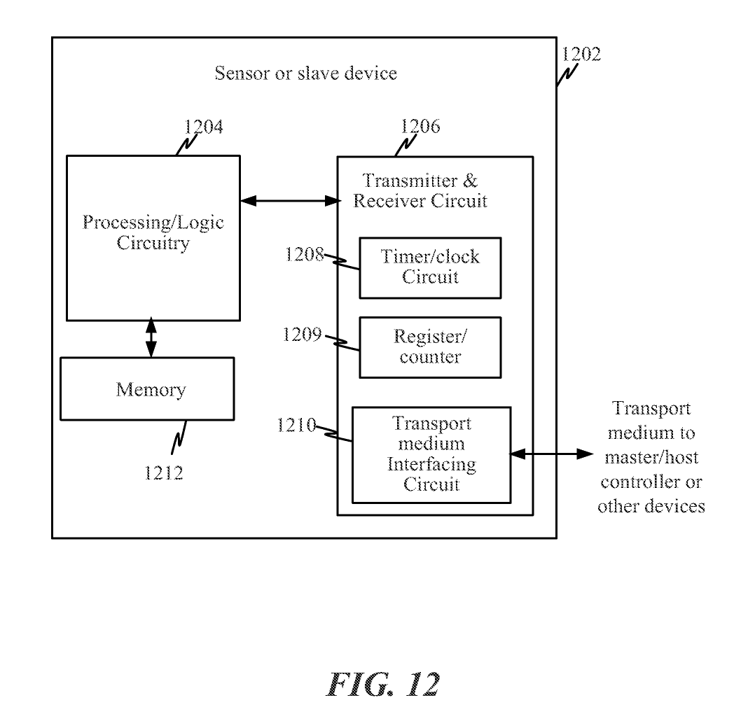

FIG. 12 illustrates an exemplary sensor or slave device 1202 that may include processing or logic circuitry 1204 coupled with a transmitter/receiver circuitry 1206 for transmitting and receiving signals and data on a bus interface or circuit communicatively coupled with at least a host controller or master device, but also other devices on the bus as well. The transmitter/receiver circuitry 1206 may include a timer circuit or clock 1208 used for determining timing for synchronization of the slave or sensor device 1202 with a host controller (e.g., controller 1102 in FIG. 11) via the bus. Additionally, the timer circuit or clock 1208 may be used for determining and marking various timestamps, particularly in connection with providing the clock counts SC1 and SC2. Although not shown, the sensor 1202 may employ other clocking or timing devices for internal clocking of the sensor, such as clocking for the processing circuitry 1204 as an example.

The transmitter/receiver circuitry 1206 also includes a register or counter 1209 that is used for counting cycles or pulses of the timer/clock circuit 1208 (e.g., pulses 410 shown in FIG. 4). Additionally, the register or counter 1209 is configured to communicatively interface with the processor circuitry 1202 in order to implement capture of the counts SC1 and SC2 or for scaling of the counts SC1 and SC2 as discussed above in connection with FIG. 6.

Further, the transmitter/receiver circuitry 1206 also include a transport medium interfacing circuit 1210 configured to interface or communicatively couple the transmitter/receiver circuitry with the physical transport medium interface, which may an I²C or I3C bus or a wireless interface as just a few examples. Furthermore, the transport medium interface may employ at least two lines such as an SDA line and SCL line, but could include further lines as discussed earlier with respect to interface 217 in FIG. 2.

The sensor 1202 also may include a memory or storage medium 1212 coupled with at least the processing circuitry 1204 and include code or instructions for causing the circuitry 1204 to implement or direct the transmitter/receiver circuit 1206 to implement the various methodologies disclosed herein, such as those disclosed in connection with FIGS. 3-10.

It should be appreciated that aspects of the invention previously described may be implemented in conjunction with the execution of instructions (e.g., applications) by processor 101 of computing device 100, host controller 205, sensor 210, host controller or master 1102, and slave or sensor device 1202 as previously described. Particularly, circuitry of the device, including but not limited to processor, may operate under the control of an application, program, routine, or the execution of instructions to execute methods or processes in accordance with embodiments of the invention (e.g., the processes illustrated by FIGS. 3-10). For example, such a program may be implemented in firmware or software (e.g., stored in memory and/or other locations) and may be implemented by processors and/or other circuitry of the devices. Further, it should be appreciated that the terms processor, microprocessor, circuitry, controller, etc., refer to any type of logic or circuitry capable of executing logic, commands, instructions, software, firmware, functionality, etc.

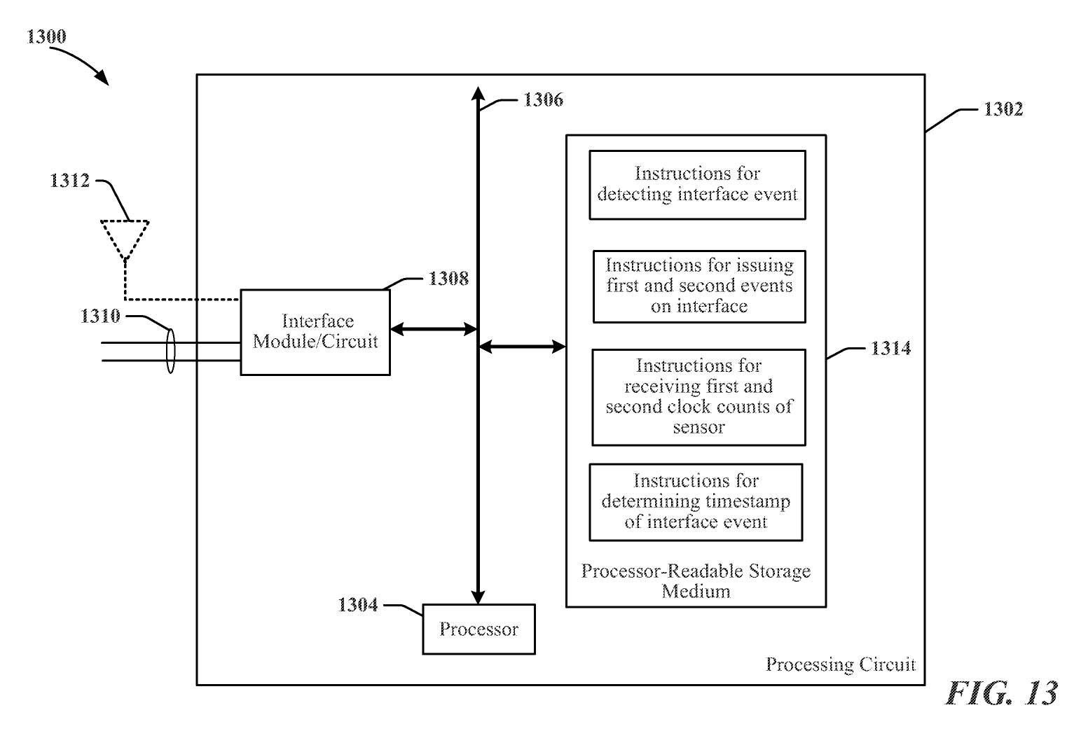

FIG. 13 is a diagram illustrating a simplified example of a hardware implementation for a host controller 1300 employing a processing circuit 1302. Examples of operations performed by the host controller 1300 include the operations described above with respect to the flow chart of FIG. 7, as well as the timelines in FIGS. 4-6. The processing circuit 1302 typically has a processor 1304 that may include one or more of a microprocessor, microcontroller, digital signal processor, a sequencer and a state machine. The processing circuit 1302 may be implemented with a bus architecture, represented generally by the bus 1306 The bus 1306 may include any number of interconnecting buses and bridges depending on the specific application of the processing circuit 1302 and the overall design constraints. The bus 1306 communicatively couples various circuits including one or more processors and/or hardware modules, represented by the processor 1304, and an interface module or circuit 1308 that is configurable to support communication over various connectors or wires 1310 operable according to various transport protocols or wireless interfaces (as shown by optional antenna 1312) and a computer-readable storage medium 1314. The bus 1306 may also link various other circuits such as timing sources, peripherals, voltage regulators, and power management circuits, which are well known in the art, and therefore, are not described in detail herein. It is also noted that the interfaces 1310 may be one or more interfaces operable according to one or multiple transport formats, as well as being communicatively coupled to one or more slave/sensor devices or to other host controllers.

The processor 1304 is responsible for general processing, including the execution of software/instructions stored on the computer-readable storage medium 1314. The software/instructions, when executed by the processor 1304, causes the processing circuit 1302 to perform the various functions described before for any particular apparatus. The computer or processor readable storage medium 1314 may also be used for storing data that is manipulated by the processor 1304 when executing software, including data decoded from symbols transmitted over the connectors or wires 1310 or antenna 1312. The processing circuit 1302 further includes at least one of the modules/circuits 1308, which may be software modules running in the processor 1304, resident/stored in the computer-readable storage medium 1314, one or more hardware modules coupled to the processor 1304, or some combination thereof. The modules/circuits 1308 may include microcontroller instructions, state machine configuration parameters, or some combination thereof.

In one configuration, the processor readable medium 1314 includes instructions for detecting an interface event, which are configured to cause the processor 1304 to perform various functions including the processes illustrated in block 702 of FIG. 7, for example. The processor readable medium 1314 also includes instructions for using first and second events on the interface, which are configured to cause the processor 1304 to perform various functions including the processes illustrated in blocks 704 and 706 of FIG. 7, for example. Additionally, the processor readable medium 1314 also includes instructions for receiving first and second clock counts of at least one sensor (e.g., SC1, SC2), which are configured to cause the processor 1304 to perform various functions including the processes illustrated in block 708 of FIG. 7, for example. Finally, the processor readable medium 1314 also includes instructions for determining the timestamp of the interface even, which are configured to cause the processor 1304 to perform various functions including the processes illustrated in block 710 of FIG. 7, for example.

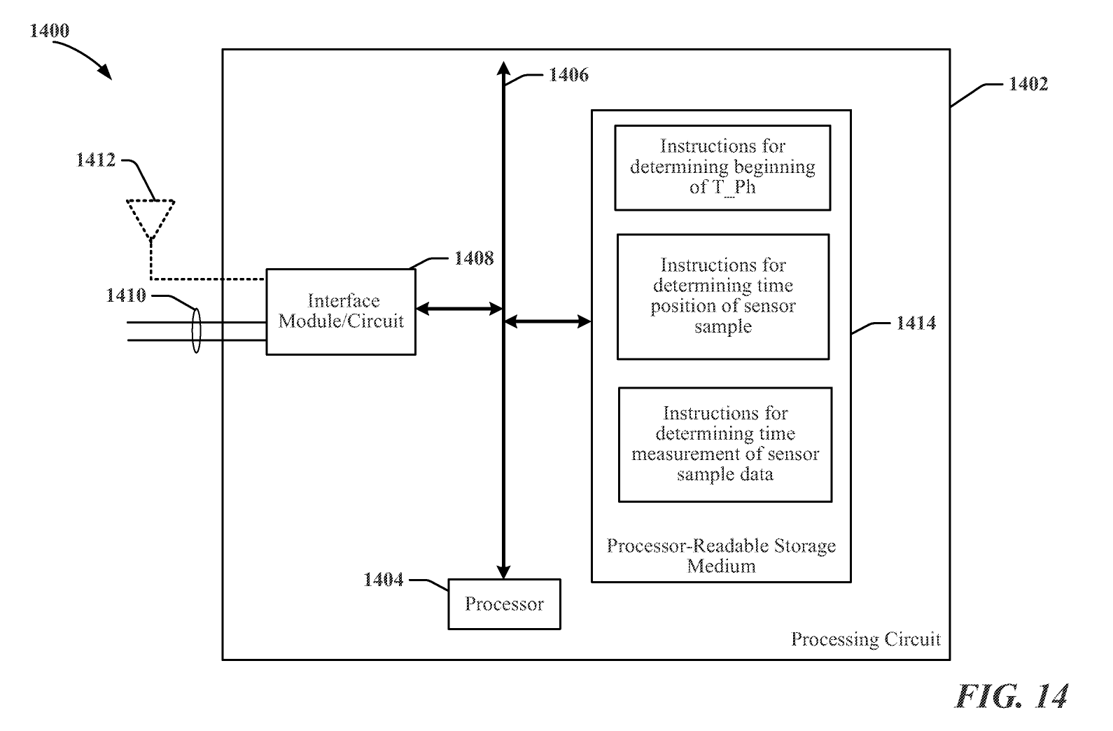

FIG. 14 is a diagram illustrating a simplified example of a hardware implementation for a host controller 1400 employing a processing circuit 1402. Examples of operations performed by the host controller 1400 include the operations described above with respect to the timeline of FIG. 9 and the flow chart of FIG. 10, for example. The processing circuit 1402 typically has a processor 1404 that may include one or more of a microprocessor, microcontroller, digital signal processor, a sequencer and a state machine. The processing circuit 1402 may be implemented with a bus architecture, represented generally by the bus 1406 The bus 1406 may include any number of interconnecting buses and bridges depending on the specific application of the processing circuit 1402 and the overall design constraints. The bus 1406 communicatively couples various circuits including one or more processors and/or hardware modules, represented by the processor 1404, and an interface module or circuit 1408 that is configurable to support communication over various connectors or wires 1410 operable according to various transport protocols or wireless interfaces (as shown by optional antenna 1412) and a computer-readable storage medium 1414. The bus 1306 may also link various other circuits such as timing sources, peripherals, voltage regulators, and power management circuits, which are well known in the art, and therefore, are not described in detail herein. It is also noted that the interfaces 1310 may be one or more interfaces operable according to one or multiple transport formats, as well as being communicatively coupled to one or more slave/sensor devices or to other host controllers.

The processor 1404 is responsible for general processing, including the execution of software/instructions stored on the computer-readable storage medium 1414. The software/instructions, when executed by the processor 1404, causes the processing circuit 1402 to perform the various functions described before for any particular apparatus. The computer or processor readable storage medium 1414 may also be used for storing data that is manipulated by the processor 1404 when executing software, including data decoded from symbols transmitted over the connectors or wires 1410 or antenna 1412. The processing circuit 1402 further includes at least one of the modules/circuits 1408, which may be software modules running in the processor 1304, resident/stored in the computer-readable storage medium 1414, one or more hardware modules coupled to the processor 1404, or some combination thereof. The modules/circuits 1408 may include microcontroller instructions, state machine configuration parameters, or some combination thereof.

In one configuration, the processor readable medium 1414 includes instructions for determining a beginning of the T_Ph period, which are configured to cause the processor 1404 to perform various functions including the processes illustrated in block 1002 of FIG. 10, for example. The processor readable medium 1414 also includes instructions for determining time position of sensor sample, which are configured to cause the processor 1404 to perform various functions including the processes illustrated in block 1004 of FIG. 10, for example. Additionally, the processor readable medium 1414 also includes instructions for determining time measurement of sensor sample data, which are configured to cause the processor 1404 to perform various functions including the processes illustrated in block 1006 of FIG. 14, for example.

Additionally the messages and events disclosed herein may be sent across many different types of interfaces and the methodology disclosed herein is not limited to any one type of interface. In a further aspect the methodology may be used on several or multiple interfaces as well as multiple interface protocols where several sensors may be synchronized against the internal time base of the host controller. It is also noted that the HW events discussed herein may be any number of known events. As an example of a HW event, the Sync Tick message (ST) itself may constitute the agreed upon event in an SPI transport, where the ST message only take 1 microsecond of time altogether, which would be sufficiently short for a synchronizing event. Other examples of HW events may be edges of the pulses on the transport medium. Some HW events may have a supplementary characteristic, such as being the last edge of a defined set of pulses. In wireless systems, the starting of communications on the wireless interface may constitute a HW event. In another example for wireless interfaces, the HW events may be communicated and through the use of special or dedicated communications or communication channels particular to various known wireless protocols.

Methods described herein may be implemented in conjunction with various wireless communication networks such as a wireless wide area network (WWAN), a wireless local area network (WLAN), a wireless personal area network (WPAN), and so on. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, and so on. A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be implemented in conjunction with any combination of WWAN, WLAN and/or WPAN. It should also be appreciated that although embodiments of the disclosure may be described in relation to interfaces/buses such as I²C, and I3C, the methods and apparatus are not limited to use with only these interfaces, and may be used with other interfaces such as SPI, SLIMbus, UART, SoundWire, etc.

Example methods, apparatus, or articles of manufacture presented herein may be implemented, in whole or in part, for use in or with mobile communication devices. As used herein, “mobile device,” “mobile communication device,” “hand-held device,” “tablets,” etc., or the plural form of such terms may be used interchangeably and may refer to any kind of special purpose computing platform or device that may communicate through wireless transmission or receipt of information over suitable communications networks according to one or more communication protocols, and that may from time to time have a position or location that changes. As a way of illustration, special purpose mobile communication devices, may include, for example, cellular telephones, satellite telephones, smart telephones, heat map or radio map generation tools or devices, observed signal parameter generation tools or devices, personal digital assistants (PDAs), laptop computers, personal entertainment systems, e-book readers, tablet personal computers (PC), personal audio or video devices, personal navigation units, or the like. It should be appreciated, however, that these are merely illustrative examples relating to mobile devices that may be utilized to facilitate or support one or more processes or operations described herein.

The methodologies described herein may be implemented in different ways and with different configurations depending upon the particular application. For example, such methodologies may be implemented in hardware, firmware, and/or combinations thereof, along with software. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

The herein described memory or storage media may comprise primary, secondary, and/or tertiary storage media. Primary storage media may include memory such as random access memory and/or read-only memory, for example. Secondary storage media may include mass storage such as a magnetic or solid state hard drive. Tertiary storage media may include removable storage media such as a magnetic or optical disk, a magnetic tape, a solid state storage device, etc. In certain implementations, the storage media or portions thereof may be operatively receptive of, or otherwise configurable to couple to, other components of a computing platform, such as a processor.

In at least some implementations, one or more portions of the herein described storage media may store signals representative of data and/or information as expressed by a particular state of the storage media. For example, an electronic signal representative of data and/or information may be “stored” in a portion of the storage media (e.g., memory) by affecting or changing the state of such portions of the storage media to represent data and/or information as binary information (e.g., ones and zeroes). As such, in a particular implementation, such a change of state of the portion of the storage media to store a signal representative of data and/or information constitutes a transformation of storage media to a different state or thing.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

Some portions of the preceding detailed description have been presented in terms of algorithms or symbolic representations of operations on binary digital electronic signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm here, and generally, is considered to be a self-consistent sequence of operations or similar signal processing leading to a desired result. In this context, operations or processing involves physical manipulation of physical quantities. Typically, although not necessarily, such quantities may take the form of electrical or magnetic signals capable of being stored, transferred, combined, compared or otherwise manipulated as electronic signals representing information. It has proven convenient at times, principally for reasons of common usage, to refer to such signals as bits, data, values, elements, symbols, characters, terms, numbers, numerals, information, or the like. It should be understood, however, that all of these or similar terms are to be associated with appropriate physical quantities and are merely convenient labels.

Unless specifically stated otherwise, as apparent from the following discussion, it is appreciated that throughout this specification discussions utilizing terms such as “processing,” “computing,” “calculating,”, “identifying”, “determining”, “establishing”, “obtaining”, and/or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. In the context of this particular patent application, the term “specific apparatus” may include a general purpose computer once it is programmed to perform particular functions pursuant to instructions from program software.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in some implementations” or other like phrases in various places throughout this specification are not necessarily all referring to the same feature, example, and/or limitation. Furthermore, the particular features, structures, or characteristics may be combined in one or more examples and/or features.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of appended claims, and equivalents thereof.

It is understood that the specific order or hierarchy of steps in the processes disclosed is merely an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for providing a timestamp in a host controller of an interface event on an interface coupled with host controller, the method comprising:
detecting a message from a sensor on the interface that identifies the issuance of the interface event caused by the sensor, the interface event occurring at a first time on the sensor;
issuing a first event on the interface at a second time after the first time in the response to the received message and starting a first count of cycles of a host controller clock, the start of the first count being concurrent with issuing the first event;
issuing a second event on the interface at third time after the second time;
receiving a first sensor clock count and a second sensor clock count from the sensor, where the first sensor clock count is a count of cycles of an internal sensor clock from the first time to the second time and the second sensor clock count is a count of cycles of the internal sensor clock from the second time to the third time; and
determining within the host controller the timestamp of the interface event corresponding to the first time based at least in part on the first count of cycles of a host controller clock, the first sensor clock count, the second sensor clock count, and a host controller timestamp of the second time.

2. The method of claim 1, wherein the host controller and the sensor are communicatively coupled via one or more of an I²C, an I3C, an SPI, an SMBus, a SLIMbus, a UART, a SoundWire bus, or a wireless interface.

3. The method of claim 1, wherein each of the first and second events comprises a predetermined hardware event known to both the host controller and the sensor.

4. The method of claim 1, wherein the message comprises an interrupt request issued by the sensor.

5. The method of claim 1, wherein the received first sensor clock count and second sensor clock count comprise reduced count number values that are reduced by a common factor such that a ratio of the first sensor clock count and the second sensor clock count remains constant regardless of the value of the common factor.

6. The method of claim 5, wherein the reducing of the values of the first and second sensor clock counts by the common factor further comprises:
reducing a current count of the first sensor clock count by a factor of two (2);
reducing a rate of counting the first sensor clock count by a factor of two (2);
reducing a current count of the second sensor clock count by at least a factor of two (2);
reducing a rate of counting the second sensor clock count by at least a factor of two (2); and
dividing a stored count of first sensor clock count by a factor of two (2) when the current count of the second sensor clock count is reduced by at least a factor of two (2).

7. The method of claim 1, wherein the first and second interface events occur after the sensor transmits a message indicating the detection of the event.

8. The method of claim 1, wherein the host controller is further configured to determine the timestamp of the interface event corresponding to the first time in terms of the time of the host controller clock, wherein the host controller determine the timestamp of the interface event according to the relationship:
Timestamp of the interface event=MREF−MC2×SC1/SC2
wherein MC1 is the first count of cycles of the host controller clock, SC1 is the first sensor clock count, SC2 is the second sensor clock count, and MREF is the host controller timestamp of the second time.

9. A host controller device comprising:
a transport medium interface communicatively coupled to at least one sensor via at least one transport medium;
at least one processing circuit communicatively coupled to the transport medium interface and configured to:
detect a message from the sensor on the interface that identifies the issuance of the interface event caused by the sensor, the interface event occurring at a first time on the sensor;
issue a first event on the interface at a second time after the first time in the response to the received message and starting a first count of cycles of a host controller clock, the start of the first count being concurrent with issuing the first event;
issue a second event on the interface at third time after the second time;
receive a first sensor clock count and a second sensor clock count from the sensor, where the first sensor clock count is a count of cycles of an internal sensor clock from the first time to the second time and the second sensor clock count is a count of cycles of the internal sensor clock from the second time to the third time; and
determine the timestamp of the interface event corresponding to the first time based at least in part on the first count of cycles of a host controller clock, the first sensor clock count, the second sensor clock count, and a host controller timestamp of the second time.

10. The host controller device claim 9, wherein the interface is at least one or more of an I²C bus, an I3C bus, an SPI bus, an SMBus, a SLIMbus, a UART bus, a SoundWire bus, or a wireless interface.

11. The host controller device claim 9, wherein each of the first and second events comprises a predetermined hardware event known to both the host controller and the sensor.

12. The host controller device claim 9, wherein the message comprises an interrupt request issued by the sensor.

13. The host controller device claim 9, wherein the received first sensor clock count and second sensor clock count comprise reduced count number values that are reduced by a common factor such that a ratio of the first sensor clock count and the second sensor clock count remains constant regardless of the value of the common factor.

14. The host controller device claim 13, wherein the reducing of the values of the first and second sensor clock counts by the common factor further comprises:
reducing a current count of the first sensor clock count by a factor of two (2);
reducing a rate of counting the first sensor clock count by a factor of two (2);
reducing a current count of the second sensor clock count by at least a factor of two (2);
reducing a rate of counting the second sensor clock count by at least a factor of two (2); and
dividing a stored count of first sensor clock count by a factor of two (2) when the current count of the second sensor clock count is reduced by at least a factor of two (2).

15. The host controller device claim 9, wherein the first and second interface events occur after the sensor transmits a message indicating the detection of the event.

16. The host controller device claim 9, wherein at least one processing circuit is further configured to determine the timestamp of the interface event corresponding to the first time in terms of the time of the host controller clock, wherein the host controller determine the timestamp of the interface event according to the relationship:
Timestamp of the interface event=MREF−MC2×SC1/SC2
wherein MC1 is the first count of cycles of the host controller clock, SC1 is the first sensor clock count, SC2 is the second sensor clock count, and MREF is the host controller timestamp of the second time.

17. A processor-readable storage medium having one or more instructions which, when executed by at least one processing circuit, cause the at least one processing circuit to:
receive a message at host controller from a sensor on an interface communicatively coupling the host controller and the sensor, the message configured to identify the issuance of the interface event caused by the sensor and occurring at a first time on the sensor;
issue a first event on the interface at a second time after the first time in the response to the received message and starting a first count of cycles of a host controller clock, the start of the first count being concurrent with issuing the first event;
issue a second event on the interface at third time after the second time;
receive a first sensor clock count (SC1) and a second sensor clock count (SC2) from the sensor, where the first sensor clock count is a count of cycles of an internal sensor clock from the first time to the second time and the second sensor clock count is a count of cycles of the internal sensor clock from the second time to the third time; and
determine the timestamp of the interface event corresponding to the first time based at least in part on the first count of cycles of a host controller clock, the first sensor clock count, the second sensor clock count, and a host controller timestamp of the second time (MREF).

18. The processor-readable storage medium of claim 17, wherein the interface comprises at least one or more of an I²C bus, an I3C bus, an SPI bus, an SMBus, a SLIMbus, a UART bus, a SoundWire bus, or a wireless interface.

19. The processor-readable storage medium of claim 17, wherein each of the first and second events comprises a predetermined hardware event known to both the host controller and the sensor.

20. The processor-readable storage medium of claim 17, wherein the message is an interrupt request issued by the sensor.

21. The processor-readable storage medium of claim 17, wherein the received first sensor clock count and second sensor clock count comprise reduced count number values that are reduced by a common factor such that a ratio of the first sensor clock count and the second sensor clock count remains constant regardless of the value of the common factor.

22. The processor-readable storage medium of claim 21, wherein the reducing of the values of the first and second sensor clock counts by the common factor further comprises:
reducing a current count of the first sensor clock count by a factor of two (2);
reducing a rate of counting the first sensor clock count by a factor of two (2);
reducing a current count of the second sensor clock count by at least a factor of two (2);
reducing a rate of counting the second sensor clock count by at least a factor of two (2); and
dividing a stored count of first sensor clock count by a factor of two (2) when the current count of the second sensor clock count is reduced by at least a factor of two (2).

23. The processor-readable storage medium of claim 17, wherein the first and second interface events occur after the sensor transmits a message indicating the detection of the event.

24. The processor-readable storage medium of claim 17, wherein the one or more instructions which, when executed by the at least one processing circuit, further cause the at least one processing circuit to determine the timestamp of the interface event corresponding to the first time in terms of the time of the host controller clock, wherein the host controller determine the timestamp of the interface event according to the relationship:
Timestamp of the interface event=MREF−MC2×SC1/SC2
wherein MC1 is the first count of cycles of the host controller clock, SC1 is the first sensor clock count, SC2 is the second sensor clock count, and MREF is the host controller timestamp of the second time.

25. A method for providing a time of measurement associated with sensor sample data, comprising:
determining a beginning time of a present time phase (T_Ph) period in a host controller;
determining a time position of a sensor sample data transmission within a sequence of sensor sample data transmissions within the present phase time period; and
determining the time of measurement associated with the sensor sample data transmission based on the beginning time of the present phase time period and the time position of the sensor sample data transmission within the sequence of sensor sample data transmissions within the present phase time period.

26. The method of claim 25, further comprising:
transmitting a synchronization signal indicative of a beginning of a new time phase period to at least one sensor;
determining a delay time between an expected beginning of the new time phase (T_Ph) period and the transmission of the synchronization signal; and
transmitting information indicative of the delay to the sensor in a first message,
wherein the sensor determines the expected beginning of the new phase time period based on a timing of the synchronization signal and the information indicative of the delay and corrects an internal timer based on the determined expected beginning of the new phase time period.

27. The method of claim 26, wherein the information indicative of the delay time indicates the delay time as a number of 1/n time periods of the time phase period, where n is 2 to a predetermined power.

28. The method of claim 26, wherein the delay time between the expected beginning of the new phase time period and the transmission of the synchronization signal is caused by hardware or software overhead in the host controller.

29. The method of claim 25, wherein the time of measurement associated with the first sensor sample data transmission within the sequence of sensor sample data transmissions is determined as the beginning time of the present time phase (T_Ph) period, and the time of measurement associated with other sensor sample data transmission within the sequence of sensor sample data transmissions are determined using linear interpolation based on the difference between the time positions of the sensor sample data transmissions within the sequence of sensor sample data transmissions and a number of transmissions within the sequence.

30. The method of claim 25, wherein the host controller and the sensor are communicatively coupled via an interface including at least one or more of an I²C bus, an I3C bus, an SPI bus, an SMBus, a SLIMbus, a UART bus, a SoundWire bus, or a wireless interface.
